(19) United States
(12) Patent Application Publication
(10) Pub. No.: US 2024/0160121 A1
(43) Pub. Date: May 16, 2024

(54) TONER, TONER SET, IMAGE TRANSFER SHEET, TONER ACCOMMODATING UNIT, IMAGE FORMING APPARATUS, AND IMAGE FORMING METHOD

(71) Applicants: Toyoshi Sawada, Shizuoka (JP); Kazumi Suzuki, Shizuoka (JP); Katsunori Kurose, Shizuoka (JP); Motoshi Iizuka, Shizuoka (JP)

(72) Inventors: Toyoshi Sawada, Shizuoka (JP); Kazumi Suzuki, Shizuoka (JP); Katsunori Kurose, Shizuoka (JP); Motoshi Iizuka, Shizuoka (JP)

(73) Assignee: Ricoh Company, Ltd., Tokyo (JP)

(21) Appl. No.: 18/509,057

(22) Filed: Nov. 14, 2023

(30) Foreign Application Priority Data
Nov. 16, 2022 (JP) 2022-183615
Aug. 22, 2023 (JP) 2023-134691

(51) Int. Cl. G03G 9/08; G03G 9/087; G03G 15/08

(52) U.S. Cl. CPC G03G 9/0825; G03G 9/0819; G03G 9/08755; G03G 9/08764; G03G 15/08

(57) ABSTRACT

A toner has a softening point Ts of below 50 degrees C. and a tangent method glass transition temperature Tg2nd of below 0 degrees C.

### CROSS-REFERENCE TO RELATED APPLICATIONS

This patent application is based on and claims priority pursuant to 35 U.S.C. § 119 to Japanese Patent Application Nos. 2022-183615 and 2023-134691, filed on Nov. 16, 2022 and Aug. 22, 2023, respectively, in the Japan Patent Office, the entire disclosures of which are hereby incorporated by reference herein.

### BACKGROUND

### Technical Field

The present disclosure relates to a toner, a toner set, an image transfer sheet, a toner accommodating unit, an image forming apparatus, and an image forming method.

### Description of the Related Art

Electrophotography is a method of developing a latent electrostatic image with a developing agent to render the latent electrostatic image visible and forms a latent electrostatic image on a latent electrostatic image bearer containing a photoconductive material, developing the latent electrostatic image with a developing agent containing toner to obtain a toner image, transferring the toner image onto a transfer material, typically paper, and fixing the toner image by applying heat and pressure to obtain a fixed image.

Electrophotography can form a full color image with a typical toner set of three process color toners of cyan toner, magenta toner, and yellow toner combined with black toner.

Currently, electrophotographic color image forming apparatuses become popular and produce printed matter with various applications. For a sector of consumable goods made to order, electrophotographic printing is highly expected to support a material on which traditional electrophotographic toner for paper media is not printable or fixable. Specifically, the need for printing on fabrics such as uniforms, shoes, and bags for sports teams is increasing.

Toners for forming fixed images on fabric must have properties traditional toners do not have.

For example, such toners have to be firmly fixed on fabric with irregularities and a toner layer is required to be flexible enough to follow the deformation of the fabric. However, a toner with excellent fixability and flexibility for media made from flexible fibers such as fabric has yet to be made.

### SUMMARY

According to embodiments of the present disclosure, a toner is provided that has a softening point Ts of below 50 degrees C. and a tangent method glass transition temperature Tg2nd of below 0 degrees C.

As another aspect of embodiments of the present disclosure, a toner set is provided that contains a color toner containing a binder resin and a colorant and the toner mentioned above.

As another aspect of embodiments of the present disclosure, an image transfer sheet is provided that includes a support for releasing and an image formed with the toner mentioned above on the support.

As another aspect of embodiments of the present disclosure, a toner accommodating unit is provided that accommodates the toner mentioned above.

As another aspect of embodiments of the present disclosure, an image forming apparatus is provided that has a latent electrostatic image bearer, a latent electrostatic image forming device for forming a latent electrostatic image on the latent electrostatic image bearer, a developing device for developing the latent electrostatic image formed on the latent electrostatic image bearer with a developing agent containing the toner mentioned above to obtain a toner image, a transfer device for transfer the toner image onto a support for releasing or a flexible printing medium with a surface roughness of 1 or more μm, and a fixing device for fixing the toner image transferred to the support or the flexible printing medium.

As another aspect of embodiments of the present disclosure, an image forming method is provided that includes forming a latent electrostatic image on a latent electrostatic image bearer, developing the latent electrostatic image formed on the latent electrostatic image bearer with a developing agent containing the toner mentioned above to obtain a toner image, transferring the toner image on the latent electrostatic image bearer overlying a support for releasing or a flexible printing medium with a surface roughness of 1 or more μm, and fixing the toner image transferred onto the support or the flexible printing medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a schematic diagram of the image forming apparatus according to an embodiment of the present invention;

FIG. 2 is a diagram illustrating a schematic diagram of a part of the image forming apparatus according to an embodiment of the present invention;

FIG. 3 is a diagram illustrating a schematic diagram of a part of the image forming apparatus according to an embodiment of the present invention;

FIG. 4 is a typical cross section image of a coarsely pulverized product of melt-kneaded mixture of toner compositions of Toner 1 described later by scanning electronic microscopy (SEM) according to an embodiment of the present disclosure; and

FIG. 5 is a schematic diagram illustrating a flow curve of the toner according to an embodiment of the present invention as measured with a flow tester.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

Within the context of the present disclosure, if a first layer is stated to be “overlaid” on, or “overlying” a second layer, the first layer may be in direct contact with a portion or all of the second layer, or there may be one or more intervening layers between the first and second layer, with the second layer being closer to the substrate than the first layer.

According to the present disclosure, a toner is provided that is flexible and fixable on a medium made from flexible fibers such as fabric on which traditional toners are not fixable.

Fabric is typically flexible and made from fibers in most cases. If toner is used for forming an image on such a flexible fibrous medium, the toner must have properties traditional toners for paper media do not have. For example, the toner has to be firmly fixed on fabrics with irregularities and a toner layer is flexible enough to follow the irregularities or the deformation of fabric.

The inventors of the present invention have thus made an investigation and found that toner with certain softening point Ts and tangent method glass transition temperature Tg2nd demonstrates highly increased fixability to fabric media and forms flexible fixed toner layers.

The present disclosure thus provides a toner with a softening point Ts of lower than 50 degrees C. and a tangent method glass transition temperature Tg2nd of lower than 0 degrees C.

The present disclosure is detailed below.

### Toner

The toner of the present disclosure has a softening point Ts of lower than 50 degrees C. and a tangent method glass transition temperature Tg2nd of lower than 0 degrees C.

A softening point Ts of 50 or higher degrees C. of the toner makes a fixed toner image tend to crack. A tangent method glass transition temperature Tg2nd of 0 or higher degrees C. degrades the toner's rubber elasticity at room temperature and lowers the elasticity of an image formed on a flexible medium, degrading the laundering fastness.

Preferably, the sea-island structure present in a scanning electron microscopic(SEM) image of a cross section of the toner of the present disclosure has at least three domains on average, each with an aspect ratio of 2 or more and an area of 0.1 or more μm² per 100 μm².

The sea-island structure is constituted of “sea” (also referred to as matrix), a continuous phase of one component of a toner, and “island” (also referred to as domain) of the other components in the “sea”.

The number of the domains with an aspect ratio of 2 or more and an area of 0.1 or more μm² present in the sea-island structure in a cross section of the toner of the present disclosure is preferably three or more on average per 100 μm² of the toner's cross section and, more preferably, five or more on average. Three or more domains with an aspect ratio of 2 or more and an area of 0.1 or more μm² present per 100 μm² of the toner's cross section makes a toner image less likely to crack.

Preferably, the sea-island structure is present in a vertical cross section SEM image of a fixed image of the toner. Preferably, the sea-island structure in the vertical cross section SEM image has a stripe pattern or filamentous domain. Toner particles are crushed and turned into a flat shape upon fixing on a support for releasing (e.g., release paper) or a printing medium. Then the domains inside the toner particles can also be crushed and turned into a flat shape, resulting in a filamentous form. If the domain further flattens, the domain in the toner's cross section also further flattens, so the domain part and the matrix part in the sea-island structure form a layer structure looking as if they are laminated. The portion with this layer structure looks striped.

In the present specification, “filamentous” refers to an aeolotropic but not isotropic form excluding a true circle form. Specifically, it refers to a thin needle-like or thread-like form.

In the present specification, the term “filamentous domain” refers to a domain with a shape with a length of the most extended side of 0.1 or longer μm, an aspect of the most extended side length to the minimum side length of 2 or greater, and an area of 0.1 or greater μm².

In the present specification, the term “the sea-island structure has a stripe pattern” means that the sea-island structure in the vertical cross section in a fixed toner image forms a layer structure with its domain and matrix parts laminated, including the striped structure.

The toner of the present disclosure may contain a binder resin (resin for fixing) and other optional materials such as a releasing agent, a colorant, a charge control agent, an external additive, a developing agent, and other components such as a flow improver, a charge control agent, and a magnetic material.

Toner preferably has a sea-island structure with the domain mentioned above in its cross section to be fixable on a flexible medium such as fabric and to produce a flexible fixed toner image. The toner of the present disclosure has a softening point Ts of lower than 50 degrees C. and a tangent method glass transition temperature Tg2nd of lower than 0 degrees C. The toner structure mentioned above is associated with the softening point and the glass transition temperature of the toner of the present disclosure. Suppose a toner with a low glass transition temperature has a sea-island structure with domains and matrix present in the toner as described above. In that case, the toner has heat stability and demonstrates rubber elasticity, and an image formed on a flexible medium is less likely to crack.

### Binder Resin

In the present disclosure, known resins can be used as the binder resin (resin for fixing) as a toner component in the toner of the present disclosure.

Specific examples of the binder resin include, but are not limited to, styrene, styrene-based resins (homopolymers or copolymers of styrene or styrene substitute) such as poly-α-styrene, styrene-chlorostyrene copolymers, styrene-propylene copolymers, styrene-butadiene copolymers, styrene-vinyl chloride copolymers, styrene-vinyl acetate copolymer, styrene-maleic acid copolymer, styrene-acrylic acid ester copolymer, styrene-methacrylic acid ester copolymer, styrene-α-chloroacrylic acid methyl copolymer, and styrene-acrylonitrile-acrylic acid-ester copolymers, epoxy resins, vinyl chloride resins, rosin-modified maleic acid resins, phenol resins, polyethylene resins, polypropylene resins, petroleum resins, polyurethane resins, polyester resins, ketone resins, ethylene-ethyl acrylate copolymers, xylene resins, and polyvinyl butyrate resins. The method of manufacturing these resins is also not particularly limited. Any methods such as bulk polymerization, solution polymerization, emulsion polymerization, and suspension polymerization can be utilized.

The toner of the present disclosure preferably contains at least polyurethane resin as a binder resin. The polyurethane resin is a binder resin suitable for the present disclosure because it has excellent tensile strength, abrasion resistance, elasticity, and oil resistance. Compositionally, polyurethane resins obtained from substances such as 1,4-butanediol (1,6-hexane diol). adipic acid, and diphenylmethane diisocyanate are preferable. There is no specific limitation to procurable polyurethane resins. It can be suitably selected to suit to a particular application.

Specific examples include, but are not limited to, hotmelt powder ECOFREEN POWDER, available from ECOFREEN, T8175N, available from DIC Covestro Copolymer Ltd., and P22MBRANAT, available from Nippon Miractan Co., Ltd.).

The toner of the present disclosure preferably contains a polyester resin as a binder resin. Polyester resins can be fixed at low temperatures while maintaining high temperature and high humidity storage stability compared with other resins. For this reason, it is a binder resin suitable for the toner of the present disclosure.

Polyester resins for use in the present disclosure are preferably obtained by polycondensation of an alcohol with a carboxylic acid. Alcohol to be used is not particularly limited and can be suitably selected to suit to a particular application.

Specific examples include, but are not limited to, glycols such as ethylene glycol, diethylene glycol, triethylene glycol, and propylene glycol, 1,4-bis(hydroxymethyl)cyclohexane, etherified bisphenols such as bisphenol A, diol monomers, tri- or higher polyol monomers.

Carboxylic acid is not particularly limited and can be suitably selected to suit to a particular application.

Specific examples include, but are not limited to, two-valent organic acid monomers such as maleic acid, fumaric acid, phthalic acid, isophthalic acid, terephthalic acid, succinic acid, and moronic acid; and tri- or higher carboxylic acid monomers such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylene carboxy propane, and 1,2,7,8-octane tetracarboxylic acid.

The polyurethane resin preferably has a softening point Ts of 45 or lower degrees C. and a tangent method glass transition temperature Tg2nd of 45 or lower degrees C. A softening point Ts of 45 or lower degrees C. and a tangent method glass transition temperature Tg2nd of 45 or lower degrees C. of the polyurethane resin can afford a flexible fixed toner image.

The polyester resin preferably has a softening point Ts of 60 or more degrees C. and a tangent method glass transition temperature Tg2nd of 60 or more degrees C. A softening point Ts of 60 or more degrees C. and a tangent method glass transition temperature Tg2nd of 60 or more degrees C. of the polyester resin can afford a flexible fixed toner image.

A combination of polyurethane resin with polyester resin can easily form a non-compatible sea-island structure, so it is preferable to use the polyurethane resin with the polyester resin.

Preferably, the toner of the present disclosure containing a polyurethane resin and a polyester resin has a cross section with a sea-island structure including domains containing the polyurethane resin and matrix containing the polyester resin. Preferably, the domains are incompatible with the matrix.

The polyurethane resin preferably has a weight average molecular weight of from 20,000 to 100,000, more preferably from 20,000 to 80,000, and furthermore preferably from 20,000 to 60,000. A weight average molecular weight of 20,000 or greater prevents a fixed image from running upon ironing it. A weight average molecular weight of 100,000 or less facilitates the melt-kneading of an adhesive with other toner components during toner production.

The proportion of the polyurethane is not particularly limited and can be suitably selected to suit to a particular application. In a toner containing a binder resin and a releasing agent, the proportion of the polyurethane resin is preferably from 5 to 40 percent by mass and more preferably from 10 to 30 percent by mass to the entire of the binder resin and the releasing agent. A proportion of the polyurethane resin of 5 or more percent by mass to the total mass of the binder resin and the releasing agent provides a toner that can be fixed on a flexible medium such as fabric and form a flexible fixed toner layer. A proportion of the polyurethane resin of 40 or less percent by mass does not degrade the toner's thermal stability and prevents toner particles from agglomerating.

In addition, all or a part of the polyurethane resin can be substituted with any polyethylene terephthalate, polyethylene isophthalate, polybutylene terephthalate, polybutylene isophthalate, and styrene-butadiene rubber having the same characteristics as the polyurethane resin.

### Non-Compatible Domain

The size and shape of the domain in toner can be confirmed by observing a reflected electron image with an SEM. The presence of the sea part (matrix) and the island part (non-compatible domain) in the sea-island structure of toner can be recognized by the color difference. Dyeing a sea-island structure with ruthenium tetroxide is an option for making a contrast, facilitating the determination.

One way of observing a reflected electron images with an SEM is in the following manner under the following conditions.

The sea-island structure relating to the present disclosure is present in toner particles, even in a coarsely pulverized product of melt-kneaded mixture of toner compositions.

For example, a toner particle or a particle of a coarsely pulverized product of melt-kneaded mixture of toner compositions is embedded in epoxy resin and cut out to see a cross section, which is observed with an SEM (SU8230, available from Hitachi Ltd.) under the following conditions. During the observation, the non-dyed portions are observed as dark, being distinct from the dyed portions, i.e., light portions.
Accelerated voltage: 5 kV
Emission current: 10 μA
Probe current: Norm
Condenser lens 1:5.0
W.D.: 8.0 mm
Observation mode: SE
Factor: ×2,000 or 5,000

### Aspect Ratio and Area of Domain

The aspect ratio of a domain is defined as the ratio of the most extended side length to the shortest side length of a domain in the island (domain) of a sea-island structure in an SEM image of the cross section of the toner of the present disclosure. A larger aspect ratio is associated with high isotropics. The area of a domain is defined as the area of an island (domain) of a sea-island structure in an SEM image of toner's cross section of the toner of the present disclosure.

### Average Number of Specific Domains per 100 μm² of Toner's Cross Section

One way of obtaining the average number of domains with an aspect of 2 or greater and an area of 0.1 or greater μm² per 100 μm² of a toner's cross section is as follows.

At least ten toner particles with a particle diameter of from 10 to 20 μm are prepared from Toner X and the toner's cross section of a toner particle out of the at least ten toner particles is imaged with an SEM at a substantially middle point of the particle diameter. Of the domains present in the SEM image of the toner's cross section, the number of domains with an aspect of 2 or greater and an area of 0.1 or greater μm² and their cross section's area are counted to obtain the number of domains with an aspect of 2 or greater and an area of 0.1 or greater μm² per 100 μm². The rest of the toner particles of Toner X undergo the same operation. The number of the domains with an aspect of 2 or greater and an area of 0.1 or greater μm² per 100 μm² is summed, followed by dividing by the number of toner's cross sections used. The quotient obtained is the average number of the domains with an aspect of 2 or greater and an area of 0.1 or greater μm² per 100 μm² of Toner X.

### Imaging Fixed Image with SEM

The same method of imaging a fixed image with an SEM as that described in Non-compatible Domain is adopted except that a fixed image is used as a sample.

### Method of Measuring Volume-Based Particle Diameter and Particle Size Distribution of Toner

The volume-based particle size distribution and particle diameter can be measured with, for example, a particle size measuring device (Multisizer III, available from Beckman Coulter, Inc.) at an aperture of 100 μm, followed by analyzing with an analysis software called BeckmanCoulterMultisizer 3 Version 3.51). An example thereof is as follows.

Specifically, 0.5 ml of 10 percent by mass surfactant (alkylbenzene sulfonate, NEOGEN SC-A, available from Daiichi Kogyo Co., Ltd.) is placed in a glass beaker (100 ml). A total of 0.5 g of each toner is loaded into the beaker and stirred by a micro spatula. Next, 80 ml of deionized water is added to the mixture to obtain a liquid dispersion. The thus-obtained liquid dispersion is subjected to dispersion treatment for ten minutes with an ultrasonic wave dispersion device (W-113MK-II, available from Honda Electronics) to obtain the toner's liquid dispersion sample. The toner's liquid dispersion sample is measured with the MULTISIZER III mentioned above using ISOTON® III (available from BECKMAN COULTER INC.) as a measuring solution to obtain the toner's particle diameter and particle size distribution. The sample is added dropwise to measure the volume average particle diameter of the toner while achieving a concentration of 8±2 percent according to the device's indication to reproduce measurements without an error for the particle diameter.

### Toner's Particle Size Distribution and Volume Average Particle Diameter

The toner of the present disclosure is not particularly limited regarding the volume-based particle size distribution and can be suitably selected to suit to a particular application. A particle size distribution with a peak in a range of from 5 to 30 μm is preferable, and from 10 to 20 more preferable. The term “peak” in a particle size distribution refers to the peak top thereof being within the range specified above.

The volume average particle diameter of the toner is not particularly limited and can be suitably selected to suit to a particular application. For example, the volume average particle diameter is preferably from 5 to 30 μm and more preferably from 10 to 20 μm.

Such a toner can have a toner layer with an increased pile height by increasing the toner particle diameter. The toner has thus excellent concealing property, facilitating filling the irregularities on the surface of a flexible medium such as fabric. In addition, it is preferable for the toner to have a volume-based particle size distribution with a peak within a range of from 10 to 20 μm to balance the toner size with transferability. For the same reason, a toner with a volume average particle diameter of from 10 to 20 μm is more preferable.

### Confirmation of Presence and Quantification of Resin in Toner

The toner of the present disclosure can be preferably confirmed and quantified with a Gas Chromatography-Mass spectrometry (GC-MS) or Nuclear Magnetic resonance (NMR). Specific procedures, devices, and conditions are as follows.

### Compositional Analysis by GC-MS

### Preparation of Sample

Toner is dispersed in chloroform, followed by agitating for 24 hours to obtain a liquid dispersion. This liquid dispersion is then centrifuged to retrieve the supernatant alone. The supernatant retrieved is subjected to evaporation to obtain a dry solid, followed by compositional analysis with a GC-MS. One measuring condition using a GC-MS is as follows. A sample mixture is prepared by adding approximately 1 μL of a methylating agent [20 percent methanol solution of tetramethylammonium hydroxide (TMAH)] dropwise to about 1 g of a sample.

### Measuring Conditions

Pyrolysis-gas chromatograph mass spectrometry (Py-GCMS): QP2010, available from Shimadzu Corporation
Heating furnace: Py2020 D, available from Frontier Laboratories Ltd.
Heating Temperature: 320 degrees C.
Column: Ultra ALLOY-5 (L=30 m, I.D=0.25 mm, Film=0.25 μm, available from GL Sciences Inc.
Column temperature: 50 degrees C. (held for 1 minute)—heated (10 degrees C/minute) to 340 degrees C. (held for 7 minutes)
Split ratio: 1:100
Column flow rate: 1.0 mL/min
Ionization method: EI method (70 eV)
Measuring mode: Scan mode
Data for retrieval: NIST 20 MASS SPECTRAL LIB.

### Compositional Analysis by NMR

### Preparation of Sample

Toner is dispersed in chloroform, followed by agitating for 24 hours to obtain a liquid dispersion. This liquid dispersion is then centrifuged to retrieve the supernatant alone. The dry solid retrieved is used as a sample for ¹H-NMR and ¹³C-NMR, and subjected to compositional analysis by NMR. A specific method of preparing a sample for ¹H-NMR and a sample for ¹³C-NMR and specific measuring conditions are as follows.

### 1. Method of Preparing Sample for ¹H-NMR

A total of 1 mL of d8-toluene (available from FUJIFILM Wako Pure Corporation) is added to 100 mg of the sample, followed by melting with heat of a dryer to prepare a sample for ¹H-NMR.

### 2. Method of Preparing Sample for ¹³C-NMR

A total of 1 mL of deuterated 1,2-dichloro toluene (available from FUJIFILM Wako Pure Corporation) is added to 100 mg of the sample, then melted with heat of a dryer to prepare a sample for ¹³C-NMR.

### Measuring Conditions

NMR device: ECX-500, available from JEOL Ltd.
Measuring nucleus=¹H (500 MHz), measuring pulse file=single pulse dec.jxp (1H), 45 degrees C. pulse, quantity survey of 20,000 times, Relaxation Delay −4 seconds, data point of 32 K, Offset of 100 ppm, measuring width of 250 ppm, measuring temperature 70 degrees C.
Measuring nucleus=¹³C (125 MHz), measuring pulse file=single pulse dec.jxp (13C), 45 degrees C. pulse, quantity survey of 64 times, Relaxation Delay 5 seconds, data point of 32 K, Offset of 15 ppm, measuring width of 15 ppm, measuring temperature 65 degrees C.

### Measuring of Weight Average Molecular Weight

The weight average molecular weight of resin for use in the toner can be obtained by measuring the molecular weight distribution for the resin dissolved in tetrahydrofuran (THF) with a GPC measuring device. There is no specific limit to the GPC measuring device, and it can be suitably selected to suit to a particular application. An example is GPC-150C, available from Waters Corporation.

The column for use in measuring the weight-average molecular weight is not particularly limited and can be suitably selected to suit to a particular application.

Specific examples include, but are not limited to, KF801 (column for organic solvent-based SEC (GPC)), KF802 (column for organic solvent-based SEC (GPC)), KF803 (column for organic solvent-based SEC (GPC)), KF804 (column for organic solvent-based SEC (GPC)), KF805 (column for organic solvent-based SEC (GPC)), KF806 (column for organic solvent-based SEC (GPC)), and KF807 (column for organic solvent-based SEC (GPC)) (all available from Showa Denko K.K.).

The method of measuring the weight average molecular weight of resins for use in the toner is not particularly limited and can be suitably selected to suit to a particular application. One way of measuring is as follows.

THF, as a solvent, is caused to flow at 1 mL per minute in a column stabilized in a heat chamber at 40 degrees C. Then a THF solution containing a sample of 0.05 g is filtered with a pre-processing filter (e.g., Chromatodisk with an aperture of 0.45 μm, available from KURABO INDUSTRIES LTD.) to adjust a sample concentration of from 0.05 to 0.6 percent by mass in the end. A total of 50 to 200 μL of the THF sample solution at the adjusted concentration is infused into a column to separate the sample dissolved in THF from the THF sample solution. The separated portion is converted into molecular weight using a differential refractive index (RI) detector (GPC-150C, available from Waters Corporation) to measure the weight average molecular weight Mw of the sample dissolved in THF contained in the THF sample solution.

The weight average molecular weight Mw and the number average molecular weight Mn of the THF dissolved portion in the sample are calculated from the relationship between the count values and the logarithm values of the calibration curves made from several types of monodispersed polystyrene standard samples.

As the standard polystyrene sample for the calibration curve, it is suitable to use at least about ten standard polystyrene samples individually having a molecular weight of 6×10², 2.1×10², 4×10², 1.75×10⁴, 5.1×10⁴, 1.1×10⁵, 3.9×10⁵, 8.6×10⁵, 2×10⁶, or 4.48×10⁶, available from TOSOH CORPORATION or Pressure Chemical Co., for example.

A refractive index (RI) detector is preferable as a detector.

### Method of Measuring Softening Point Ts

The softening point of the toner of the present disclosure can be measured with, for example, a flow tester, CFT-500D, available from Shimadzu Corporation. One way of measuring the softening point is to: pelletize toner particles under a minimum pressure at which the toner can be molded into tablets; store the pellets in a thermostatic chamber at 80 degrees C. for 30 minutes; leave them to natural cooling to room temperature; and measure the flow tester softening point Ts and the outflow start temperature Tfb of the cooled pellets as a toner sample. The flow tester softening point Ts and the outflow start temperature Tfb of the toner can be obtained from the flow curve measured with, for example, a flow tester CFT-500, available from Shimadzu Corporation. The flow curve can be measured under the following measuring conditions.
Amount of sample: 1.00±0.05 g
Start temperature: 40 degrees C.
Peak temperature: 200 degrees C.
Temperature rising speed: 3.0 degrees C./min
Load for test: 22.5 kgf
Die opening diameter: 0.5 mm
Die length: 1.0 mm

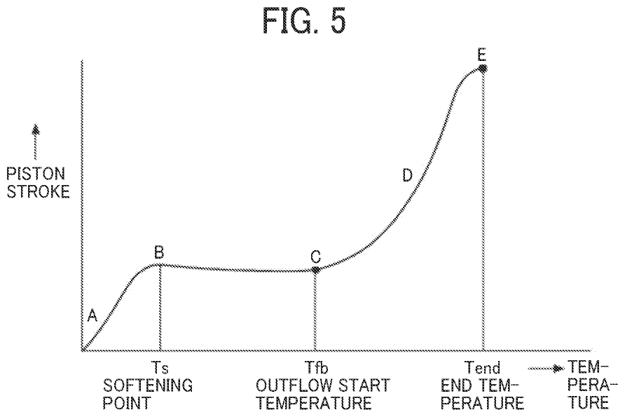

FIG. 5 is a schematic diagram illustrating the flow curve of the toner according to an embodiment of the present disclosure as measured with a flow tester. In FIG. 5, Ts represents the softening point and Tfb represents the outflow start temperature.

Exceptionally, the software installed in the flow tester cannot automatically detect Ts if the piston stroke curve in the measuring with the flow tester does not show a shoulder, corresponding to Ts, Then Ts is determined as below 40 degrees C. in measuring of the toner of the present disclosure.

### Method of Measuring Tangent Method Glass Transition Temperature Tg2nd

The melting point and the glass transition temperature Tg of the toner of the present disclosure can be measured with a device such as differential scanning calorimetry (DSC) system, Q-200, available from TA Instruments.

The melting point and the glass transition temperature of a target sample are measured in the following manner.

About 5.0 mg of a target sample is put in an aluminum sample container, which is placed on a holder unit. The unit and the container are then disposed in an electric furnace. Next, the unit and container are heated in a nitrogen atmosphere from −50 to 150 degrees C. at a temperature rising speed of 10 degrees C./min for the first temperature rise. Thereafter, the system is cooled down from 150 to −50 degrees C. at a temperature falling speed of −10 degrees C./min and heated again to 150 degrees C. at a temperature rising speed of 10 degrees C./min for the second temperature rise. In each of the first temperature rise and second temperature rise, the DSC curve is measured with a differential scanning calorimeter, Q-200, available from TA Instruments.

The DSC curve for the second temperature rise is selected from the obtained DSC curve using the analysis program installed in the Q-200 system to obtain the tangent method glass transition temperature Tg2nd of the target sample at the second temperature rise.

### Releasing Agent

Any releasing agent (wax) can be used and selected to suit to a particular application. The releasing agent can be used alone or in combination.

The releasing agent that can be used in the present disclosure is not particularly limited and can be suitably selected to suit to a particular application.

Specific examples include, but are not limited to, aliphatic hydrocarbons such as liquid paraffin, microcrystalline wax, natural paraffin, synthetic paraffin, polyolefin wax, and partial oxides, fluorides, and chlorides thereof; animal oil such as beef tallow and fish oil; vegetable oils such as coconut oil, soybean oil, rapeseed oil, rice bran wax, and carnauba wax; higher aliphatic alcohol or aliphatic acid such as montan wax; aliphatic acid amide, aliphatic acid bisamide; metal soap such as zinc stearate, calcium stearate, magnesium stearate, aluminum stearate, zinc oleate, zinc palmitate, magnesium palmitate, zinc myristate, zinc laurate, and zinc behenate; aliphatic acid esters, and polyvinylydene fluoride. Of these, a releasing agent containing at least ester wax such as fatty acid esters is preferable.

Ester wax, as a releasing agent, can inhibit waste paper jamming caused by failing to separate the toner from a fixing roller or belt during fixing when the toner contains an extreme amount of maleic acid modified polyolefin with a polypropylene block in its main chain. Moreover, ester wax can be finely dispersed in the toner by the maleic acid modified polyolefin with a polypropylene block in its main chain.

The proportion of the releasing agent in a toner is not particularly limited and can be suitably selected to suit to a particular application. It is preferably from 0.1 to 8.0 percent by mass and more preferably from 1.0 to 6.0 percent by mass. A content of 0.1 or more percent by mass separates the toner from a fixing roller or belt during fixing, reducing the occurrences of waste paper jamming. A content of 8.0 or less percent by mass firmly fixes toner on plastic film.

### Colorant

The colorant for use in the toner of the present disclosure is not particularly limited, and any typical colorant can be used. It includes, but is not limited to, black toner, cyan toner, magenta toner, yellow toner, white pigments, green toner, and blue toner.

Black toner is not particularly limited and can be suitably selected to suit to a particular application. Simple carbon black will do, and carbon black, as the main component, with other substances such as copper phthalocyanine is preferable to adjust the hue and luminosity.

Cyan toner is not particularly limited and can be suitably selected to suit to a particular application. Pigment Blue 15:3 as copper phthalocyanine or a mixture of the colorant with aluminum phthalocyanine is preferable.

Magenta toner is not particularly limited and can be suitably selected to suit to a particular application.

Specific examples include, but are not limited to, Pigment Red 53:1, Pigment Red 81, Pigment Red 122, Pigment Red 269, and a mixture thereof.

Yellow toner is not particularly limited and can be suitably selected to suit to a particular application.

Specific examples include, but are not limited to, Pigment Yellow 74, Pigment Yellow 155, Pigment Yellow 180, Pigment Yellow 185, and a mixture thereof. Using simple Pigment Yellow 185 or a mixture of Pigment Yellow 185 with Pigment Yellow 74 is preferable to enhance saturation and storage stability.

White pigment is not particularly limited and can be suitably selected to suit to a particular application. For example, titanium dioxide surface treated with a substance such as silicon, zirconia, aluminum, and polyol can be used.

Green toner is not particularly limited and can be suitably selected to suit to a particular application. For example, Pigment Green 7 can be used with a care for safety.

Blue toner is not particularly limited and can be suitably selected to suit to a particular application. It includes, but is not limited to, Pigment Blue 15:1 and Pigment Violet 23.

A typical toner layer can be formed on the toner of the present disclosure as an under layer, which is placed at the closest to a support for releasing or a printing medium (i.e., in contact with a support for releasing or a printing medium). The typical toner layer can be thus well fixed overlying a fabric medium with many irregularities characterized by its fiber with the layer of the toner of the present disclosure therebetween.

The toner of the present disclosure has rubber elasticity, so a printed toner image is not likely to crack, demonstrating resistance to expanding, bending, and laundering. In order not to affect the tinge of color of a toner image formed on the underlayer in addition to this character, the toner of the present disclosure forming an underlayer is preferable to contain no or white colorant.

### Charge Control Agent

The toner of the present disclosure may optionally contain a charge control agent.

The charge control agent is not particularly limited and can be suitably selected to suit to a particular application.

Specific examples include, but are not limited to, modified products such as nigrosine and metal salts of aliphatic acids; onium salts such as phosphonium salts and lake pigments thereof; triphenylmethane dyes and lake pigments thereof; metal salts of higher aliphatic acids; diorganotin oxides such as dibutyltin oxide, dioctyltin oxide and dicyclohexyltin oxide; diorganotin borates such as dibutyltin borate, dioctyltin borate, dicyclohexyltin borate; organometallic complexes, chelate compounds, monoazo metal complexes, acetylacetone metal complexes, metal complexes of aromatic hydroxycarboxylic acids and aromatic dicarboxylic acid; and quaternary ammonium salts. Other examples include, but are not limited to, aromatic hydroxycarboxylic acid, aromatic mono- and polycarboxylic acid and their metal salts, anhydrides, esters, and phenol derivatives such as bisphenol. These can be used alone or in combination.

The proportion of the charge control agent internally added to an electrophotographic toner is not particularly limited and can be suitably set to suit to a particular application. A proportion of 0.1 to 10 percent by mass is preferable to the entire of a binder resin. Preferably, the charge control agent is totally or almost transparent to prevent the charge control agent from coloring the toner except for black toner.

### External Additive

The toner of the present disclosure can use substances such as inorganic fine particles (inorganic particulates) as external additives.

The inorganic particulates externally added to the toner of the present disclosure are not particularly limited and can be suitably selected to suit to a particular application.

Specific examples include, but are not limited to, silica, alumina, titanium oxide, barium titanate, magnesium titanate, calcium titanate, strontium titanate, zinc oxide, silica sand, clay, mica, wollastonite, diatomaceous earth, chromium oxide, cerium oxide, iron oxide, antimony trioxide, magnesium oxide, zirconium oxide, barium sulfate, barium carbonate, calcium carbonate, silicon carbide, and silicon nitride. Of these, silica, alumina, and titanium oxide are preferable.

This inorganic fine particle may be surface-treated with a hydrophobizing agent. The hydrophobizing agent is not particularly limited and can be suitably selected to suit to a particular application. Examples include, but are not limited to, silane coupling agents, silylating agents, silane coupling agents with a fluorinated alkyl group, organic titanate-based coupling agents, and aluminum-based coupling agents. It also includes silicone oil.

The average diameter of the primary particle of the inorganic fine particles is not particularly limited and can be suitably selected to suit to a particular application. It is preferably 5 to 500 nm and more preferably from 5 to 200 nm. An average diameter of 5 or more nm inhibits the agglomeration of inorganic fine particles, uniformly dispersing the inorganic fine particles in the toner. An average diameter of 500 or less nm can enhance the thermal storage stability through the filler effect. One way of obtaining the average particle diameter is to directly measure the particle diameter from a photo taken with a transmission electron microscope (TEM). Preferably, 100 or more inorganic fine particles are present to obtain the average major diameter.

### Developing Agent

The toner of the present disclosure mixed with the carrier mentioned above can be used as a developing agent. The developing agent of the present disclosure contains the toner according to an embodiment of the present invention and other optional components such as a carrier. With the developing agent, an underlayer with excellent fixability can be formed on the fabric's surface.

The developing agent can be a one-component developing agent or a two-component developing agent. If the developing agent is used in a high-performance printer supporting high speed information processing of late, a two-component developing agent is preferable to enjoy a longer working life.

As for the toner according to an embodiment of the present invention used as a one-component development, the toner particle size does not vary upon toner replenishment. Due to this stable toner particle size, the toner is less likely to form a film on the developing roller and fusion-bond on the members such as a blade for regulating the thickness of the toner layer. The toner can thus produce quality images with good and stable developability even after agitating in the developing device for an extended period of time.

The toner according to an embodiment of the present invention can be mixed with a carrier to form a two-component developing agent. This agent can be used for electrophotography using a two-component developing agent. As for the toner according to an embodiment of the present invention used as a two-component development, the toner particle size does not vary upon toner replenishments for an extended period of time. Due to this stable toner particle size, the toner can thus produce quality images with good and stable developability even after agitating in the developing device for an extended period of time.

### Magnetic Material

The magnetic particulate of the magnetic carrier used in a two-component developing agent is not particularly limited and can be suitably selected to suit to a particular application.

Examples of the magnetic particulates include, but are not limited to, spinel ferrites such as powdered iron, magnetite, and gamma ferric oxide, spinel ferrites containing one or two types of non-iron metals such as Mn, Ni, Zn, Mg, and Cu, magnetoplumbite type ferrites such as barium ferrite, and iron or alloyed metal particles with an oxidized layer on the surface. Of these, white materials are preferable in terms of color tone.

The magnetic particulate includes a granular, spherical, or acicular magnetic particulate.

Using ferromagnetic particulates such as iron is preferable to obtain a strongly magnetized carrier.

Of these, spinel ferrite such as magnetite and gamma ferric oxide and magnetoplumbite type ferrite such as barium ferrite are preferable to be chemically stable.

Specific examples include, but are not limited to, MFL-C 35S, MFL-C 35HS (available from Powdertech CO., Ltd.), DFC-C 400M, DFC-C 410M, and SM-C 350NV (available from Dowa IP Creation Co., Ltd.).

A resin carrier with a desired magnetization can be used depending on the type and content of a ferromagnetic particle (carrier).

Preferably, such a resin carrier has a magnetization of from 30 to 150 emu/g in 1,000 oersted.

Such resin carriers can be manufactured by spraying a melt-kneaded material containing magnetized particulates and an insulating binder resin with a spray drier. Also, it is possible to manufacture resin carriers by reacting and curing monomers or prepolymers in an aqueous medium under the presence of magnetized particulates. The resin carrier obtained has magnetized particulates (carriers) dispersed in a condensation type binder.

The magnetized carrier can be coated with resin or have positively or negatively charged particulates or electroconductive particulates fixated on the surface of the magnetized carrier to control the chargeability.

The coating material (resin) for the surface of the magnetized carrier includes, but is not limited to, silicone resins, acrylic resins, epoxy resins, and fluorochemical resins.

Furthermore, the coating may contain positively or negatively charged or electroconductive particulates. Of these, silicone resins and acrylic resins are preferable.

In the present disclosure, the mass ratio of the carrier to the developing agent accommodated in a developing device is preferably 85 to less than 98 percent by mass.

A mass ratio of the carrier to a developing agent of 85 or more parts by mass reduces toner scattering from a developing device and decreases the production of defective images.

A mass ratio of the carrier to the developer of less than 98 percent by mass prevents an extreme increase in the charge size of the electrophotographic developing toner and minimizes the shortage of supply of the electrophotographic developing toner, reducing the production of defective images attributable to a decrease in the image density.

### Flow Improver

The present disclosure may contain a flow improver as an additive. There is no particular limitation to the flow improver mentioned above and it can be suitably selected to suit to a particular application as long as it is surface-treated for enhancing hydrophobicity and can keep the fluidity and chargeability even in a highly humid environment.

Specific examples include, but are not limited to, silane coupling agents, silylating agents, silane coupling agents including an alkyl fluoride group, organic titanate coupling agents, aluminum-containing coupling agents, silicone oil, and modified silicone oil.

Silica and titanium oxide as the external additives mentioned above are preferably hydrophobic silica and hydrophobic titanium formed by surface-treating silica and titanium oxide with such a flow improver.

### Cleaning Improver

The present disclosure may contain a cleaning improver as an additive. The cleaning improver is not particularly limited and can be suitably selected to suit to a particular application as long as the cleaning improver added to the toner according to an embodiment of the present invention can remove the developing agent remaining on the latent electrostatic image bearer or a primary transfer medium after image transfer.

Specific examples include, but are not limited to, zinc stearate, calcium stearate, and aliphatic metal salts of stearic acid, polymer fine particles such as polymethyl methacrylate fine particles and polystyrene fine particles, which are prepared by a soap-free emulsion polymerization method. The polymer particulates are preferable to have a relatively sharp particle size distribution with a volume average particle diameter of from 0.01 to 1 μm.

### Method of Manufacturing Toner

The method of manufacturing the toner of the present disclosure is not particularly limited and can be suitably selected to suit to a particular application. One way of manufacturing the toner of the present disclosure is described below.

It is suitable to manufacture the toner by melt-kneading pulverization. This is because melt-kneading pulverization includes cold rolling required to form filamentous domains from melt-kneaded matter of toner components.

The polymerization method, such as suspension of solution and solvent removal method, can be adopted with the toner composition formulation and processes that can form filamentous domains.

The size and the shape of filamentous domains are related to the compatibility between the domain materials and matrix materials (depending on the molecular weight and compositions of individual materials) and the force of extension applied to a melt-kneaded substance during cold rolling. The easiest method of controlling the domain's size and shape is to employ materials non-compatible with each other and adjust the melt-kneaded substance of the toner material to have an appropriate thickness (preferably 1 or less mm) based on the relationship between the domain's size and shape and the rolled thickness obtained in advance. The resulting domain is large and filamentous.

One embodiment of the method of manufacturing the toner of the present disclosure includes obtaining a binder resin mixture (mixing process), obtaining a kneaded substance of the mixture (melt-kneading process), obtaining a solid of kneaded substance (solidifying process), and obtaining a pulverized substance of the solid (finely pulverizing process), and classifying and collecting the pulverized substance (classifying process).

### Obtaining Mixture of Binder Resin (Mixing Process)

A binder resin, a colorant, a releasing agent, and optional substances such as a charge control agent are mixed with a mixer to obtain a mixture (mixing process).

The mixer is not particularly limited and can be suitably selected to suit to a particular application. Examples include, but are not limited to, a Henschel Mixer (FM20B, available from NIPPON COKE & ENGINEERING. CO., LTD.) and a super mixer (SMV-20Ba, available from KAWATAMFG Co., Ltd.).

### Obtaining Kneaded Substance of Mixture (Melt-kneading Process)

Then the mixture obtained is melt-kneaded using a melt-kneading machine to obtain a kneaded substance (melt-kneading process).

The melt-kneading device is not particularly limited and can be suitably selected to suit to a particular application.

Specific procurable products include, but are not limited to, a two-screw extruder (PCM series, available from IKEGAI CORPORATION), a TEM extruder (available from SHIBAURA MACHINE CO., LTD.), a two-screw extruder PCM kokneader, available from Buss AG, and an open roll continuous kneader (KNEADEX, available from NIPPON COKE & ENGINEERING. CO., LTD.).

### Obtaining Solid of Kneaded Substance (Solidifying Process)

Then the kneaded substance obtained is cooled and solidified to obtain a solid (solidifying process). There is no specific limit to the cooling and solidifying and it can be suitably selected to suit to a particular application. Any method known in the art can be used.

### Obtaining Pulverized Substance of Solid (Finely-Pulverizing Process)

Next, the solid obtained is finely pulverized to obtain a pulverized substance (finely pulverizing process). The solid can be pulverized by a method known in the art. It includes, but is not limited to, a method using a jet mill for pulverizing a solid toner in a jet air stream with the energy generated at collision between the toner and a collision board, a method of colliding toner particles in an air stream, and a mechanical pulverization method of supplying toner into narrow gaps of a rotor rotating at high speed.

### Classifying and Collecting Pulverized Substance (Classifying Process)

Next, the pulverized substance is classified, and the classified substances with a particular volume average particle diameter are collected. A toner is thus obtained (classifying process). The classifying method is not particularly limited and can be suitably selected to suit to a particular application. Toners can be classified by any classification method.

The toner according to an embodiment of the present invention can be manufactured by a suspension of solution and solvent removal method. In the suspension of solution and solvent removal method, an oil phase, in which toner materials containing a binder resin, a colorant, a releasing agent, and other optional materials such as a charge control agent are dissolved or dispersed, is dispersed in an aqueous medium (aqueous phase) to allow the binder resin to react. This reaction affords a liquid dispersion containing a dispersion (oil droplets) containing a prepolymer of emulsified or dispersed toner materials. Thereafter, the organic solvent is removed from the liquid dispersion, followed by filtering, rinsing, drying, and optional processes such as classifying. Mother toner particles are thus obtained. The toner according to an embodiment of the present invention is obtained by granulating the mother particles obtained by a suspension of solution and solvent removal method.

The organic solvent is not particularly limited and can be suitably selected to suit to a particular application. An organic solvent with a boiling point of 150 or lower degrees C. is preferable because it is easy to remove.

There is no specific limitation to the selection of the organic solvents with a boiling point of 150 or lower degrees C. and can be suitably selected to suit to a particular application. Specific examples include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These can be used alone or in combination.

Of these, ethyl acetate, toluene, xylene, benzene, methylene chloride, 1,2-dichloroethane, chloroform, and carbon tetrachloride are preferable and ethyl acetate is particularly preferable.

The aqueous medium is not particularly limited and can be suitably selected to suit to a particular application. It includes, for example, water, a solvent miscible with water, and a mixture thereof. These can be used alone or in combination. Of these, water is preferable.

The solvent miscible with water is not particularly limited and can be suitably selected to suit to a particular application. It includes, for example, alcohol, dimethyl formamide, tetrahydrofuran, cellosolves, and lower ketones.

Alcohol is not particularly limited and can be suitably selected to suit to a particular application. It includes, for example, methanol, isopropanol, and ethylene glycol.

Lower ketones are not particularly limited and can be suitably selected to suit to a particular application. It includes, for example, acetone and methylethyl ketone.

The method of removing the organic solvent from a liquid dispersion is not particularly limited and can be suitably selected to suit to a particular application. It includes, for example, a method of evaporating the organic solvent in oil droplets by gradually heating the entire reaction system and a method of spraying a liquid dispersion in dried atmosphere to remove the organic solvent in oil droplets.

Classification in the suspension of solution and solvent removal method can be carried out by removing fine particles in liquid with a cyclone, decanter, or centrifuge or performed after drying a liquid dispersion.

### Toner Set

The toner set of the present disclosure is composed of a color toner containing a binder resin and a colorant and the toner of the present disclosure.

The color toner is not particularly limited and can be selected among known color toners. The binder resin in a color toner is not particularly limited and can be suitably selected to suit to a particular application. This binder resin can be the same as that in the toner according to an embodiment of the present invention. The colorant is not particularly limited and can be suitably selected among known colorants to suit to a particular application.

The toner set mentioned above is loaded in an image forming apparatus described later and used to form images. The toner according to an embodiment of the present invention is used for image forming, so images can be formed reflecting the toner's excellent fixability on fabric.

### Image Transfer Sheet

The image transfer sheet of the present disclosure refers to a sheet with an image formed with the toner of the present disclosure. The sheet acting as a transfer medium of an image can be any sheet-like material on which an image can be formed.

Specific examples include, but are not limited to, cardboard, a postcard, a roll of paper, an envelope, plain paper, thin paper, coated paper (coated paper, art paper, or the like), tracing paper, a transparent sheet, a transparent film, and a resin film as a support for releasing. Also, a flexible printing medium such as fabric can be a sheet as a transfer medium of an image.

### Toner Accommodating Unit

The toner accommodating unit in the present disclosure includes a unit for accommodating toner and the toner of the present disclosure in the unit. The form of the toner accommodating unit is not particularly limited and can be suitably selected to suit to a particular application. Examples include, but are not limited to, units such as a toner container, a developing device, and a process cartridge.

The toner container is a vessel containing a toner.

The toner container may be also referred to as a developing agent container if the toner is used as a developing agent.

The developing agent container is not particularly limited and can be suitably selected from known containers, one of which includes a vessel and a cap or lid.

The toner container and the developing agent container vary in size, structure, and materials and are not particularly limited and can be suitably selected to suit to a particular application.

The shape of the vessel of the developing agent container is not particularly limited and can be suitably selected to suit to a particular application. Preferably, it is a cylinder with irregularities spirally formed on its inner surface. The developing agent, as a content in a vessel, quickly moves towards the vessel's exit following the rotation of the vessel. Preferably, all or part of the irregularities form a bellow-like shape. Due to such a bellow-like structure, the developing agent moves towards the exit more quickly.

The materials of the toner container and the developing agent container are not particularly limited, and they can be suitably selected to suit to a particular application. It is preferably a resin such as a polyester resin, a polyethylene resin, a polypropylene resin, a polystyrene resin, a polyvinyl chloride resin, a polyacrylic acid, a polycarbonate resin component, an ABS resin, or a polyacetal resin to demonstrate a good dimensional accuracy.

The toner container and the developing agent container are easily stored and conveyed and can be detachably attached to a process cartridge and an image forming apparatus described later, replenishing the toner or the developing agent in the accommodating unit.

The developing unit has a device for accommodating toner and developing with the toner.

The process cartridge includes at least a latent electrostatic image bearer integrated with a developing device, accommodates toner, and is detachably attachable to an image forming apparatus. The process cartridge may further include at least one member selected from the group consisting of a charger, an exposure (quencher, discharger), and a cleaning device.

The toner relating to an embodiment of the present invention is used in image forming with the toner accommodating unit relating to an embodiment of the present invention installed on the image forming apparatus of the present disclosure, so images can be formed reflecting

### Image Forming Method and Image Forming Apparatus

The image forming apparatus of the present disclosure includes a latent electrostatic image bearer, a latent electrostatic image forming device for forming a latent electrostatic image on the latent electrostatic image bearer, a developing device for developing the latent electrostatic image formed on the latent electrostatic image bearer with a developing agent containing the toner of the present disclosure to obtain a toner image, a transfer device for transferring the visible image onto a support for releasing or flexible printing medium with a surface roughness of 1 or more a fixing device for fixing the toner image transferred onto the support or flexible printing medium, and other optional devices.

The image forming method of the present disclosure includes forming a latent electrostatic image on a latent electrostatic image bearer, developing the latent electrostatic image formed on the latent electrostatic image bearer with a developing agent containing the toner of the present disclosure to obtain a toner image, transferring the toner image on the latent electrostatic image bearer onto a support for releasing or a flexible printing medium with a surface roughness of 1 or more μm, fixing the toner image transferred onto the support or flexible printing medium, and other optional processes.

The image forming apparatus of the present disclosure suitably executes the image forming method of the present disclosure. The latent electrostatic image forming device suitably executes the forming a latent electrostatic image. The developing device suitably carries out the developing. The transferring device suitably conducts the transferring. The fixing device suitably performs the fixing. The other optional devices suitably conduct the

### Latent Electrostatic Image Bearer

The size and structure of the latent electrostatic image bearer is not particularly limited, and it can be suitably selected among the devices known in the art to suit to a particular application.

There is not specific limitation on the materials of the latent electrostatic image bearer, and it can be suitably selected to suit to a particular application.

Specific examples include, but are not limited to, inorganic compounds such as amorphous silicon and selenium for an inorganic photoconductor and organic compounds such as polysilane and phthalopolymethine for an organic photoconductor (OPC).

The latent electrostatic image bearer is not particularly limited and can be suitably selected to suit to a particular application. A latent electrostatic image bearer having a cylindrical form is preferable. The outer diameter of a cylindrical photoconductor is not particularly limited and can be suitably selected to suit to a particular application. It is preferably from 3 to 100 mm, more preferably from 5 to 50 mm, and furthermore preferably from 10 to 30 mm.

### Latent Image Forming Device and Latent Electrostatic Process

The latent electrostatic image forming device in the image forming apparatus of the present disclosure is not particularly limited and can be suitably selected to suit to a particular application as long as it can form a latent electrostatic image on the latent electrostatic image bearer. The latent electrostatic image forming device includes at least a charger that uniformly charges the surface of the image bearer and an irradiator that irradiates the surface of the image bearer in accordance with the image information obtained.

Latent electrostatic images are formed on the latent electrostatic image bearer in the latent electrostatic image forming in the image forming method of the present disclosure. The latent electrostatic image forming includes charging the surface of the latent electrostatic image bearer and irradiating the charged surface with beams of light to form a latent electrostatic image.

There is no particular limit to the charging process, and it can be suitably selected to suit to a particular application. For example, this process can be executed with a charger for applying a bias to the surface of a latent electrostatic image bearer.

There is no particular limit to the irraidiating process, and it can be suitably selected to suit to a particular application. For example, this process can be executed with an irradiator for irradiating the surface of a latent electrostatic image bearer imagewise with beams of light.

There is no particular limit to the forming a latent electrostatic image, and it can be suitably selected to suit to a particular application. Latent electrostatic images are formed by, for example, uniformly charging the surface of a latent electrostatic image bearer and irradiating the surface according to the obtained image information using a latent electrostatic image forming device.

### Charger

The charger is not particularly limited and can be suitably selected to suit to a particular application.

Specific examples include, but are not limited to, a contact type charger such as an electroconductive or semiconductive roll, brush, film, or a rubber blade, and a non-contact type charger utilizing corona discharging such as corotron or scorotron.

The charger may employ a roller form and any other form such as a magnetic brush and a fur brush, and can be selected according to the specification or form of an image forming apparatus.

Preferably, the charger is disposed in contact or non-contact with the latent electrostatic image bearer and applies a direct voltage and an alternating voltage superimposed thereon to the surface of the latent electrostatic image bearer. The charger is preferably a charging roller disposed in contact with the latent electrostatic image bearer with a gap tape therebetween. It is also preferable that the charging roller apply a direct voltage on which an alternate voltage is superimposed to charge the surface of the latent electrostatic image bearer.

The charger is not particularly limited to the contact type charging device, but is preferable because such a charger contributes to manufacturing an image forming apparatus producing less amount of ozone.

### Irradiator

The irradiator is not particularly limited and can be suitably selected to suit to a particular application as long as it can irradiate the surface of a latent electrostatic image bearer charged with the charger imagewise.

Specific examples include, but are not limited to, a photocopying optical system, a rod lens array system, a laser optical system, and a liquid crystal shutter optical system.

The light source for the irradiatior has no particular limit and can be suitably selected to suit to a particular application.

Specific examples include, but are not limited to, typical luminous materials such as a fluorescent lamp, a tungsten lamp, a halogen lamp, a mercury lamp, a sodium lamp, a light emitting diode (LED), a semiconductor laser (LD), and electroluminescence (EL).

Variety of optical filters can be used to irradiate a latent electrostatic image bearer with beams of light having only a desired wavelength.

It includes, but is not limited to, a sharp cut filter, a band-pass filter, a near infrared filter, a dichroic filter, a coherent filter, and a color conversion filter.

The rear side irradiation system, which irradiates a latent electrostatic image bearing member from its rear side, can be also employed.

### Developing Device and Developing Process

The developing device in the image forming apparatus of the present disclosure is not particular limited and can be suitably selected to suit to a particular application as long as it can develop a latent electrostatic image formed on a latent electrostatic image bearer to form a toner image. The developing device preferably includes, for example, a developing unit for accommodating toner and applying the toner to a latent electrostatic image in a contact or non-contact manner. The developing unit preferably includes a container containing the toner.

In the developing process in the image forming method of the present disclosure, a toner image is formed by sequentially developing a latent electrostatic image with multiple color toners. The toner image is formed by, for example, developing the latent electrostatic image with the toner using the developing unit.

The developing device and the developing process use the toner according to an embodiment of the present invention, It is preferable to form toner images with a developing agent containing the toner according to an embodiment of the present invention and other optional components such as a carrier.

In addition, the developing unit may be a single color or multi-color developing device. Preferably, the developing unit includes a stirrer for triboelectrically charging toner, a magnetic field generator fixed inside, and a rotatable developing agent bearer that bears a developing agent on its surface.

In the developing unit, for example, the toner and the carrier are mixed and agitated to charge the toner due to the friction therebetween. The toner is held on the surface of the rotating magnet roller, forming a magnet brush like a filament. Since the magnet roller is provided near the latent electrostatic image bearer, some toner forming the magnet brush on the magnet roller's surface is electrically attracted to the surface of the latent electrostatic image bearer. As a result, the latent electrostatic image is developed with the toner and rendered visible with the toner on the surface of the latent electrostatic image bearer.

The image forming apparatus of the present disclosure can include four developing device for color toner (black, cyan, magenta, and yellow), and another developing device for the toner of the present disclosure. The toner of the present disclosure may adopt any color, preferably colorless or white. The toner according to an embodiment of the present invention can be all or a part of the color toners of black, cyan, magenta, and yellow used in the developing device.

### Transfer Device and Transfer Process

The transfer device in the image forming apparatus of the present disclosure preferably includes a primary transfer device for transferring a toner image to an intermediate transfer body to form a complex transfer image and a secondary transfer device for transferring the complex transfer image to a support for releasing or a flexible printing medium. The intermediate transfer body is not particularly limited and can be suitably selected from the known transfer members including an intermediate transfer belt.

In the transferring process executed by the image forming apparatus of the present disclosure, a toner image is transferred to a support for releasing or a flexible printing medium. In the transferring, it is preferable to primarily transfer a toner image onto an intermediate transfer body, from which the toner image is secondarily transferred to a support for releasing or a flexible printing medium.

More preferably, the transferring includes primarily transferring toner images formed with two or more color toners, preferably full color toners, onto an intermediate transfer body, where each toner image is overlapped to form a complex transfer image and secondarily transferring the complex transfer image onto a support for releasing or a flexible printing medium.

The toner image is transferred by, for example, charging the latent electrostatic image bearer with the transfer charging unit in the transfer device.

The transfer device (the primary transfer device and the secondary transfer device mentioned above) preferably includes at least a transfer unit for peeling-charge the toner image formed on a latent electrostatic image bearer to transfer a toner image to a support for releasing or a flexible printing medium. One or more transfer devices can be provided.

Specific examples of the transfer device include, but are not limited to, a corona transfer device using corona discharging, a transfer belt, a transfer roller, a pressure transfer roller and an adhesive transfer device.

There is no particular limitation on the support for releasing, and it can be suitably selected to suit to a particular application. A typical example of the support for releasing is release paper. However, the support for releasing includes any paper to which a non-fixed developed image can be transferred, so plain paper and PET base for an overhead projector can be also used.

A typical example of the flexible printing medium with a surface roughness of 1 or more μm is fabric, which is not particularly limited and can be suitably selected to suit to a particular application as long as a non-fixed developed image can be transferred. It includes, but is not limited to, woven fabric made from fiber and non-woven fabric.

### Fixing Device and Fixing Process

There is no specific limit to the fixing device in the image forming apparatus of the present disclosure, and it can be suitably selected to suit to a particular application. Using a known heating and pressing device that applies heating and pressure is preferable. The heating and pressing device includes, but is not limited to, a combination of a heating roller and a pressing roller or a combination of a heating roller, a pressing roller, and an endless belt can be suitably used.

The fixing process executed by the image forming apparatus of the present disclosure is to fix a toner image transferred onto a substrate for releasing or a flexible printing medium with a fixing device. A toner image can be fixed every time it is transferred for each color developing agent onto a support for releasing or a flexible printing medium. Alternatively, it is possible to fix a laminated toner image formed by overlapping toner images for each color developing agent.

The fixing device includes a heating body equipped with a heat-generating member, paper or release paper brought into contact with the heating body, and a pressing member for pressing the heating body with the paper or release paper therebetween. It is preferably a heating and pressing unit that melt-fixes a non-fixed image on a support for releasing or a flexible printing medium at the passing of support or medium between the pressing member and the heating body.

There is no specific limit to the heating temperature at the heating and pressing unit, and it can be suitably selected to suit to a particular application, Preferably, the temperature is from 80 to 200 degrees C.

The surface pressure at the heating and pressing unit is not particularly limited and can be suitably selected to suit to a particular application. Preferably, it is from 10 to 80 N/cm².

In the present embodiment, a fixing device such as a known optical fixing device can be used along with or instead of the fixing device.

### Other Optional Device and Other Optional Process

The image forming apparatus of the present disclosure may furthermore optionally include other devices such as a quencher, a cleaner, a recycling device, and a control device.

The image forming method may furthermore optionally include other processes such as quenching, cleaning, and recycling.

### Quencher and Quenching Process

The quencher is not particularly limited as long as it can apply a quenching bias to a latent electrostatic image bearer. It can be selected among the known quenchers, including a quenching lamp.

The quenching process applies a quenching bias to a latent electrostatic image bearer using a quencher.

### Cleaner and Cleaning Process

The cleaner is not particularly limited and can be suitably selected among known cleaners to suit to a particular application as long as it can remove remaining on a latent electrostatic image bearer. It includes, but is not limited to, a magnetic brush cleaner, an electrostatic brush cleaner, a magnetic roller cleaner, a blade cleaner, a brush cleaner, and a web cleaner.

The cleaning process is to remove the toner mentioned above remaining on the latent electrostatic image bearer and can be executed with the cleaner mentioned above.

The cleaner in the image forming apparatus of the present disclosure can enhance the cleanability. The cleaner controls the toner's flowability by controlling the attachment force between toner particles to enhance the cleanability. In addition, controlling the properties of degraded toner leads to a long-working life or maintains the excellent cleaning performance even in a severe condition such as a high temperature and high moisture environment. Moreover, since the external additive can be sufficiently isolated from the toner on a photoconductor, the external additive accumulates at the nipping portion of the cleaning blade, forming dam layers and demonstrating good cleanability.

### Recycling Device and Recycling Process

The recycling device is not particularly limited and can be suitably selected among conveyors known in the art to suit to a particular application.

The recycling process is to return the toner removed in the cleaning process to the developing device for recycling and can be conducted by the recycling device mentioned above.

### Control Device

The control device controls the behaviors of individual devices mentioned above. There is no specific limit to the control device, and any controller can be suitably selected to suit to a particular application as long as it can control the behavior of each device. For example, controlling device such as a sequencer and a computer are preferable.

The image forming apparatus of the present disclosure can form images highly fixable on a flexible medium such as fabric with the toner according to an embodiment of the present invention. In addition, the image forming apparatus can stably produce quality images, saving the consumption power.

In the image forming method of the present disclosure, quality images highly fixable on a flexible medium such as fabric can be stably produced with the toner according to an embodiment of the present invention.

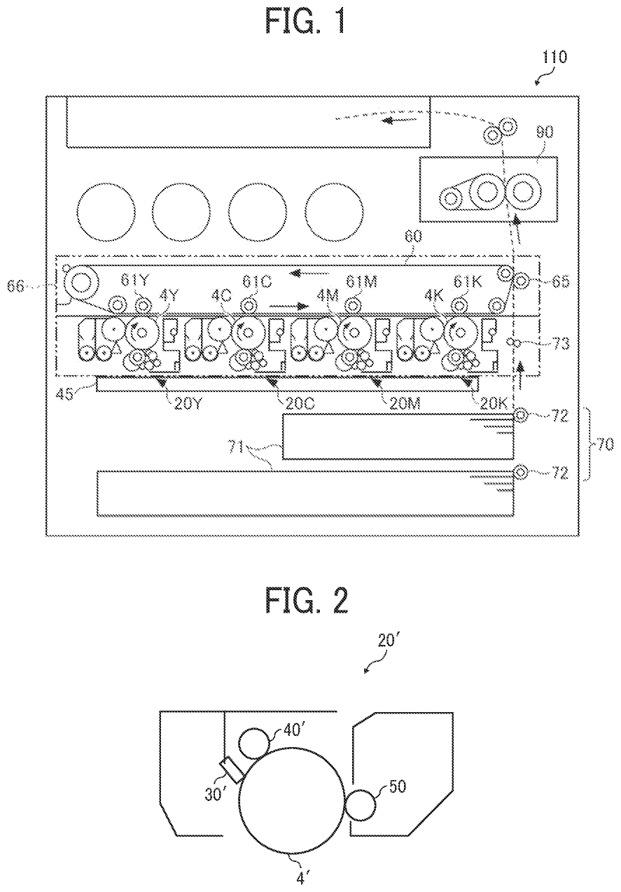

An aspect of the image forming device of the present disclosure is described with reference to FIG. 1. The present disclosure is not limited to these embodiments.

In each drawing, the same components may be denoted by the same reference numerals (symbols) and redundant description may be omitted. In addition, the present disclosure is not limited to the number, position, and shapes of the embodiments described above and those can be suitably selected to suit to implementing the present disclosure.

FIG. 1 is a diagram illustrating a schematic configuration of the image forming apparatus according to an embodiment of the present invention.

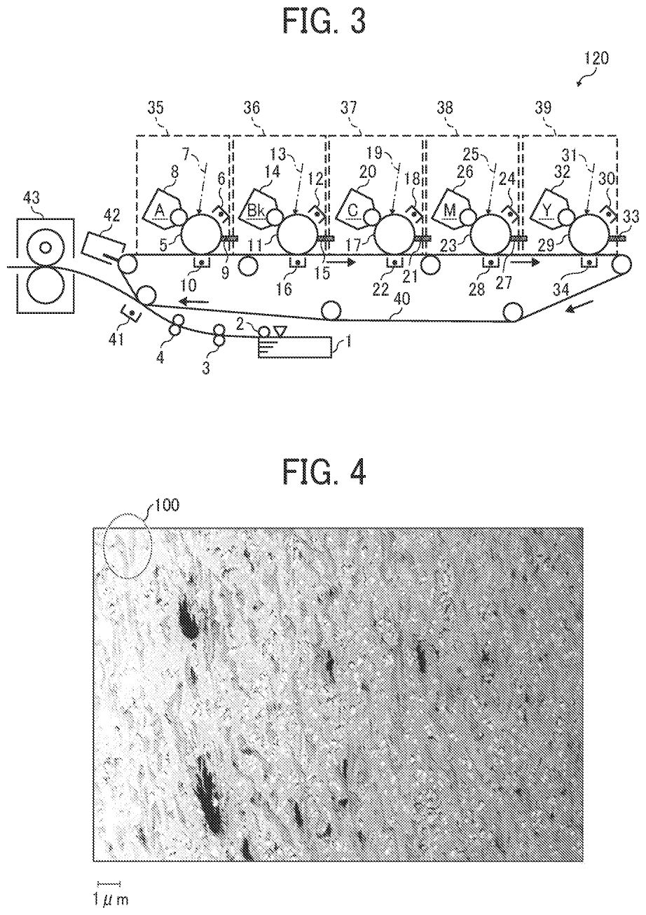

In FIG. 1, the developing device for the toner of the present disclosure is omitted. However, an image forming apparatus 110 includes the developing device for the toner of the present disclosure in the same manner as the developing devices for the toners of the other colors (FIG. 3). The image forming apparatus 110 in FIG. 1 is described assuming that an image forming unit 20A for the toner of the present disclosure, a drum photoconductor 4A as a latent electrostatic image bearer, and a primary transfer roller 61A are present for convenience.

The image forming apparatus 110 in FIG. 1 is a so-called tandem image forming apparatus, which includes toner image forming units 20Y, 20C, 20M, 20K, and 20A disposed side by side for yellow, cyan, magenta, black, and white, respectively, and overlaps the color toner images of yellow (Y), cyan (C), magenta (M), black (B), and white (A) formed by the individual toner image forming units to form a full color image. The arrangement order of the toner image forming units of the colors is not particularly limited.

The toner image forming units 20Y, 20C, 20M, 20K, and 20A respectively include drum photoconductors 4Y, 4C, 4M, 4K, and 4A rotationally driven as latent electrostatic image bearers. In addition, an irradiator 45 is disposed to irradiate each of the drum photoconductors 4Y, 4C, 4M, 4K, and 4A with laser beams or LED light based on the image information of each color to form latent images.

An intermediate transfer belt 60 whose surface is movable is disposed as an intermediate transfer member, facing each of the toner image forming units 20Y, 20C, 20M, 20K, and 20A. Primary transfer rollers 61Y, 61C, 61M, 61K, and 61A for transferring the respective color toner images formed on the drum photoconductors 4Y, 4C, 4M, 4K, and 4A to the intermediate transfer belt 60 are respectively disposed, facing the drum photoconductors 4Y, 4C, 4M, 4K, and 4A via the intermediate transfer belt 60.

The primary transfer rollers 61Y, 61C, 61M, 61K, and 61A sequentially transfer the color toner images formed by the toner image forming units 20Y, 20C, 20M, 20K, and 20A described later onto the intermediate transfer belt 60 to form an overlapped full-color image thereon.

A secondary transfer device 65 that collectively transfers the toner image on the intermediate transfer belt 60 onto a transfer medium is disposed downstream of the primary transfer rollers 61Y, 61C, 61M, 61K, and 61A in the surface moving direction of the intermediate transfer belt 60. Moreover, a belt cleaning device 66 for removing the toner remaining on the surface of the intermediate transfer belt 60 is disposed downstream of the secondary transfer device 65.

A sheet feeding unit 70 including members such as sheet feeding cassettes 71 and sheet feeding rollers 72 is disposed at the bottom of the image forming apparatus 110 and feeds the transfer medium toward registration rollers 73. The registration rollers 73 send the transfer medium toward the opposing portion of the intermediate transfer belt 60 and the secondary transfer device 65 in accordance with the timing of the toner image formation. The full color toner image on the intermediate transfer belt 60 is transferred onto the transfer medium by the secondary transfer device 65, fixed by the fixing device 90, and thereafter ejected outside the machine.

Each of the toner image forming units 20Y, 20C, 20M, 20K, and 20A is then described below. Since the configuration and operation of each of the toner image forming units 20Y, 20C, 20M, 20K, and 20A are substantially the same except that the color of the accommodated toner is different, the suffixes Y, C, M, K, and A are omitted in the following descriptions of the configuration and operation of the toner image forming unit 20′. FIG. 2 is a diagram illustrating a schematic configuration of a part of the image forming apparatus according to an embodiment of the present invention.

Various devices for conducting the electrophotographic processes such as a charger 40′, a developing device 50′, and a cleaner 30′ are disposed around a drum photoconductor 4′ as a latent electrostatic image bearer of the toner image forming unit 20′ to form each color toner image on the drum photoconductor 4′ by known operations. Such a toner image forming unit 20′ can be a process cartridge integrated in and detachably attachable to the image forming apparatus.

FIG. 3 is a diagram illustrating a part of a schematic configuration of the image forming apparatus according to an embodiment of the present invention. The overlapping description of the image forming apparatus described above is omitted.

An image forming apparatus 120 according to an embodiment of the present invention includes a photoconductors (a photoconductor 5, a photoconductor 11, a photoconductor 17, a photoconductor 23, and a photoconductor 29) as latent electrostatic image bearers. Around the photoconductors are disposed chargers (a charger 6, a charger 12, a charger 18, a charger 24, and a charger 30, developing devices (a developing device 8, a developing device 14, a developing device 20, a developing device 26, and a developing device 32), transfer units (a transfer unit 10, a transfer unit 16, a transfer unit 22, a transfer unit 28, and a transfer unit 34) as transfer devices, and cleaners (a cleaner 9, a cleaner 15, a cleaner 21, a cleaner 27, and a cleaner 33). The photoconductors are irradiated with beams of light (beams of light 7, beams of light 13, beams of light 19, beams of light 25, and beams of light 31).

Each color developing unit includes the devices such as the photoconductor, the charger, the developing device, and the cleaner. A developing unit 35 forms an image with the toner of the present disclosure, a developing unit 36 forms an image with a black toner, a developing unit 37 forms an image with a cyan toner, a developing unit 38 forms an image with a magenta toner, and a developing unit 39 forms an image with a yellow toner. Each developing unit transfers the corresponding image to an intermediate transfer belt 40 to form an image. The image formed on the intermediate transfer belt 40 is transferred onto a transfer medium by a transfer device 41 and fixed by a fixing device 43. Below the developing unit are disposed a feeding cassette 1 and a sheet feeding roller 72, which feeds a transfer medium towards registration rollers 3 and 4. The registration rollers 3 and 4 send out the transfer medium toward the opposing portion of the intermediate transfer belt 40 and the transfer device 41 in accordance with the timing of the toner image formation.

Preferably, the toner image of the present disclosure is formed on the transfer medium.

The transfer medium is preferably a support for releasing and can be a flexible printing medium.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative examples but not limited thereto.

### Manufacturing Toner

### Manufacturing Example of Toner 1

### Raw Materials of Toner 1

Polyurethane resin, ECOFREEN POWDER (softening point of 40 degrees C., tangent method glass transition temperature Tg2nd of 42 degrees C., available from ECOFREEN): 5 parts by mass
Polyester resin, RN-306 (softening point of 60 degrees C., tangent method glass transition temperature Tg2nd of 61 degrees C., available from Kao Corporation): 90 parts by mass
Ester wax, WEP-5, available from NOF CORPORATION): 5 parts
Titanium Oxide (white pigment, PF-739, available from ISHIHARA SANGYO KAISHA, LTD.): 65 parts

The raw materials of Toner 1 were preliminarily mixed by a HENSCHEL MIXER (FM20B, available from NIPPON COKE & ENGINEERING CO., LTD.) and thereafter, melt-kneaded at 100 to 130 degrees C. by a one-shaft kneader (BUSS Kokneader, MDK46-11D, available from Buss AG). The melt-kneaded matter obtained was cold rolled with a rolling mill roll to achieve a thickness of 1 or less mm. According to an investigation made before, this thickness is found to form filamentous domains. However, the melt-kneaded matter obtained in Comparative Example 1 had a thickness of 3 mm after cold rolling because it was too hard to achieve a thickness of 1 or less mm. The resulting matter was coarsely pulverized with Rotoplex, available from “TOA KIKAI KOGYO”. To have a particle diameter of from 200 to 300 μm. The substance obtained in the coarsely pulverizing process is a coarsely pulverized product of melt-kneaded mixture of toner compositions.

Next, the coarsely pulverized product was finely-pulverized under an adjusted pulverization air pressure with a counter jet mill (100AFG, available from Hosokawa Micron Corporation) to achieve a weight average molecular weight of from 10 to 15 μm. The finely pulverized product was classified by an air classifier (EJ-LABO, available from MATSUBO Corporation) with a louver aperture adjusted to achieve a weight average molecular weight of 1.0±0.5 μm to prepare mother toner particles.

Then 1.0 part by mass of Additive 1 (silca, HDK-2000, available from Clariant AG) and 1.0 part by mass of Additive 2 (silica, HO5TD, available from Clariant AG) were admixed and agitated with 100 parts of the mother toner by a HENSCHEL MIXER to prepare Toner 1.

In preparing the toner, the pulverization property, the degree of easiness of pulverizing toner by the counter jet mill, was visually checked along with the attachability of the toner to the wall of the mill. The results are shown in Table 1 below.

### Manufacturing Example of Toner 2

### Raw Materials of Toner 2

Polyurethane resin, ECOFREEN POWDER, available from ECOFREEN: 10 parts by mass
Polyester resin, RN-306: 85 parts by mass
Ester wax, WEP-5, available from NOF CORPORATION): 5 parts
Titanium Oxide (white pigment, PF-739, available from ISHIHARA SANGYO KAISHA, LTD.): 65 parts

Toner 2 was manufactured in the same manner as in Manufacturing Example of Toner 1 except that the raw materials were changed to those of Toner 2 specified above. The pulverization property and attachability in manufacturing Toner 2 were also visually checked. The observation results are shown in Table 1.

### Manufacturing Example of Toner 3

### Raw Materials of Toner 3

Polyurethane resin, ECOFREEN POWDER, available from ECOFREEN: 30 parts by mass
Polyester resin, RN-306: 65 parts by mass
Ester wax, WEP-5, available from NOF CORPORATION): 5 parts
Titanium Oxide (white pigment, PF-739, available from ISHIHARA SANGYO KAISHA, LTD.): 65 parts

Toner 3 was manufactured in the same manner as in Manufacturing Example of Toner 1 except that the raw materials were changed to those of Toner 3 specified above. The pulverization property and attachability in manufacturing Toner 3 were also visually checked. The observation results are shown in Table 1.

### Manufacturing Example of Toner 4

### Raw Materials of Toner 4

Polyurethane resin, ECOFREEN POWDER, available from ECOFREEN: 40 parts by mass
Polyester resin, RN-306: 55 parts by mass
Ester wax, WEP-5, available from NOF CORPORATION): 5 parts
Titanium Oxide (white pigment, PF-739, available from ISHIHARA SANGYO KAISHA, LTD.): 65 parts

Toner 4 was manufactured in the same manner as in Manufacturing Example of Toner 1 except that the raw materials were changed to those of Toner 4 specified above. The pulverization property and attachability in manufacturing Toner 4 were also visually checked. The observation results are shown in Table 1.

### Manufacturing Example of Toner 5

### Raw Materials of Toner 5

Polyurethane resin, ECOFREEN POWDER, available from ECOFREEN: 50 parts by mass
Polyester resin, RN-306: 45 parts by mass
Ester wax, WEP-5, available from NOF CORPORATION): 5 parts
Titanium Oxide (white pigment, PF-739, available from ISHIHARA SANGYO KAISHA, LTD.): 65 parts

Toner 5 was manufactured in the same manner as in Manufacturing Example of Toner 1 except that the raw materials were changed to those of Toner 5 specified above. The pulverization property and attachability in manufacturing Toner 5 were also visually checked. The observation results are shown in Table 1.

### Manufacturing Example of Toner 6

### Raw Materials of Toner 6

Polyurethane resin, ECOFREEN POWDER, available from ECOFREEN: 3 parts by mass
Polyester resin, RN-306: 92 parts by mass
Ester wax, WEP-5, available from NOF CORPORATION): 5 parts
Titanium Oxide (white pigment, PF-739, available from ISHIHARA SANGYO KAISHA, LTD.): 65 parts

Toner 6 was manufactured in the same manner as in Manufacturing Example of Toner 1 except that the raw materials were changed to those of Toner 6 specified above. The pulverization property and attachability in manufacturing Toner 6 were also visually checked. The observation results are shown in Table 1. However, the melt-kneaded matter obtained in Manufacturing Example of Toner 6 had a thickness of 3 mm after cold rolling because it was too hard to achieve a thickness of 1 or less mm,

### Measuring Softening Point Ts of Toner

The softening point of Toner 1 was measured with a flow tester, CFT-500D, available from Shimadzu Corporation.

Toner 1 was pelletized under the minimum pressure at which Toner 1 was moldable into tablets. The pellets obtained were stored in a thermostatic chamber at 80 degrees C. for 30 minutes, followed by leaving them to natural cooling to room temperature to obtain a toner sample. Its flow tester softening point Ts and outflow start temperature Tfb of the toner sample were then measured.

The flow tester softening point Ts and the outflow start temperature Tfb of Toner 1 can be obtained from the flow curve measured with a flow tester CFT-500, available from Shimadzu Corporation. The flow curve can be measured under the following measuring conditions.
Amount of sample: 1.00±0.05 g
Start temperature: 40 degrees C.
Peak temperature: 200 degrees C.
Temperature rising speed: 3.0 degrees C./min
Load for test: 22.5 kgf
Die opening diameter: 0.5 mm
Die length: 1.0 mm

The software installed in the flow tester cannot automatically detect Ts if the piston stroke curve in the measuring with the flow tester does not show a shoulder, corresponding to Ts. Then Ts was determined as below 40 degrees C.

The softening point Ts was obtained in the same manner for Toners 2 to 6. The results are shown in Table 1.

### Measuring Tangent Method Glass Transition Temperature Tg2nd of Toner

The melting point and the glass transition temperature Tg of Toner 1 were measured with a differential scanning calorimetry (DSC) system, Q-200, available from TA Instruments.

About 5.0 mg of a target sample was put in an aluminum sample container, which was then placed on a holder unit. Next, the unit and the container were disposed in an electric furnace.

Next, the unit and container were heated in a nitrogen atmosphere from −50 to 150 degrees C. at a temperature rising speed of 10 degrees C./min for the first temperature rise.

Thereafter, the system was cooled down from 150 to −50 degrees C. at a temperature falling speed of −10 degrees C./min and heated again to 150 degrees C. at a temperature rising speed of 10 degrees C./min for the second temperature rise.

In each of the first temperature rise and second temperature rise, the DSC curve was measured with a differential scanning calorimeter, Q-200, available from TA Instruments.

The DSC curve for the second temperature rise was selected from the obtained DSC curve using the analysis program installed in the Q-200 system to obtain the tangent method glass transition temperature Tg2nd of the target sample at the second temperature rise.

The tangent method glass transition temperature Tg2nd was obtained in the same manner for Toners 2 to 6.

The results are shown in Table 1.

### Measuring Volume Average Particle Diameter of Toner

The volume average particle diameter of Toner 1 was measured with a particle size measuring device (Multisizer III, available from Beckman Coulter, Inc.) at an aperture of 100 μm, followed by analyzing with an analysis software called BeckmanCoulterMultisizer 3 Version 3.51).

Specifically, 0.5 ml of 10 percent by mass surfactant (alkylbenzene sulfonate, NEOGEN SC-A, available from Daiichi Kogyo Co., Ltd.) was placed in a glass beaker (100 ml). A total of 0.5 g of each toner was added in the beaker and stirred by a micro spatula. Next, 80 ml of deionized water was added to the mixture to obtain a liquid dispersion. The thus-obtained liquid dispersion was subjected to dispersion treatment for ten minutes with an ultrasonic wave dispersion device (W-113MK-II, available from Honda Electronics) to obtain the toner's sample liquid dispersion of Toner 1. The particle diameter of Toner 1 was measured for the sample liquid dispersion with the MULTISIZER III mentioned above using ISOTON® III (available from BECKMAN COULTER INC.) as a measuring solution. In measuring, the sample liquid dispersion of Toner 1 was added dropwise to achieve a concentration of 8±2 percent indicated by the device to impart measuring reproducibility without an error of the particle diameter. The volume average particle diameter of Toner 1 was calculated from the found values of the particle diameter.

The volume average particle diameter was obtained in the same manner for Toners 2 to 6. Toners 1 to 6 had a volume average particle diameter of 11.0±0.5 μm.

### Observation on Toner's Cross Section (Coarsely Pulverized Product of Melt-Kneaded Mixture of Toner Compositions)

The presence of the sea-island structure in Toners 1 to 6 was confirmed by observing reflected SEM electron images of the particle's cross section of the coarsely pulverized product of melt-kneaded mixture of toner compositions of each toner. The presence of the sea part and the island part (non-compatible domain) can be identified by the color difference between polyester and urethane. Optionally, the sea-island structure with ruthenium tetroxide, available from TAAB Laboratories Equipment Ltd., was dyed for making a contrast, facilitating the determination. The cross section of each of the ruthenium-dyed coarsely pulverized products of melt-kneaded mixture of toner compositions was imaged by SEM at a substantially middle point of the particle diameter in the following conditions to confirm the presence of a sea-island structure.

The procedures are as follows.

Each particle of the coarsely pulverized products of melt-kneaded mixture of toner compositions of Toners 1 to 6 was embedded in epoxy resin and observed with an SEM (SU8230, available from Hitachi Ltd.) under the following conditions. During the observation, the non-dyed portions are observed as dark, being distinct from the dyed portions, i.e., light portions.
Accelerated voltage: 5 kV
Emission current: 10 μA
Probe current: Norm
Condenser lens 1:5.0
W.D.: 8.0 mm
Observation mode: SE
Factor: ×2,000 or 5,000

The sea-island structure was present in the cross sections of the coarsely pulverized products of melt-kneaded mixture of toner compositions of Toners 1 to 5, while Toner 6 did not have a sea-island structure in the cross section.

FIG. 4 is a typical SEM cross section image of a coarsely pulverized product of melt-kneaded mixture of toner compositions of Toner 1 according to an embodiment of the present invention.

A numerical reference “100” representing the long and thin portion with a dark color in an ellipse in FIG. 4 is a domain (island).

### Composition of Matrix and Domain

The materials contained in the matrix (sea portion) and domains (island portion) of the cross section of the coarsely pulverized product of melt-kneaded mixture of toner compositions and the cross section of a fixed image of Toners 1 to 5, which were confirmed to have a sea-island structure, were identified in the following manner.

### Compositional Analysis

### Preparation of Sample

The coarsely pulverized product of melt-kneaded mixture of toner compositions of fixed image of each toner was dispersed in chloroform, followed by stirring for 24 hours to obtain a liquid dispersion. This liquid dispersion was then centrifuged to retrieve the supernatant alone. The supernatant retrieved was evaporated to obtain a dry solid, followed by compositional analysis with a GC-MS. The measuring conditions using a GC-MS are as follows. A sample mixture was prepared by adding approximately 1 μL of a methylating agent [20 percent methanol solution of tetramethylammonium hydroxide (TMAH)] dropwise to a sample of about 1 mg.

### Measuring Conditions

Pyrolysis-gas chromatograph mass spectrometry (Py-GCMS): QP2010, available from Shimadzu Corporation
Heating furnace: Py2020 D, available from Frontier Laboratories Ltd.
Heating Temperature: 320 degrees C.
Column: Ultra ALLOY-5 (L=30 m, I.D=0.25 mm, Film=0.25 μm, available from GL Sciences Inc.
Column temperature: 50 degrees C. (held for 1 minute)—heated (10 degrees C./minute) to 340 degrees C. (held for 7 minutes)
Split ratio: 1:100
Column flow rate: 1.0 mL/min
Ionization method: EI method (70 eV)
Measuring mode: Scan mode
Data for retrieval: NIST 20 MASS SPECTRAL LIB.

### Compositional Analysis by NMR

### Preparation of Sample

The coarsely pulverized product of melt-kneaded mixture of toner compositions of fixed image of each toner was dispersed in chloroform. Followed by stirring for 24 hours to obtain a liquid dispersion. This liquid dispersion was then centrifuged to retrieve the supernatant alone. The dry solids retrieved were used as a sample for ¹H-NMR and ¹³C-NMR, and subjected to compositional analysis by NMR. The methods of preparing a sample for ¹H-NMR and a sample for ¹³C-NMR and specific measuring conditions are as follows.

### 1. Method of Preparing Sample for ¹H-NMR

A total of 1 mL of d8-toluene (available from FUJIFILM Wako Pure Corporation) was added to 100 mg of the sample, followed by melting with heat by a dryer to prepare a sample for ¹H-NMR.

### 2. Method of Preparing Sample for ¹³C-NMR

A total of 1 mL of deuterated 1,2-dichloro toluene (available from FUJIFILM Wako Pure Corporation) was added to 100 mg of the sample, then melted with heat of a dryer to prepare a sample for ¹³C-NMR.

### Measuring Conditions

NMR device: ECX-500, available from JEOL Ltd.
Measuring nucleus=¹H (500 MHz), measuring pulse file=single pulse dec.jxp (1H), 45 degrees C. pulse, quantity survey of 20,000 times, Relaxation Delay −4 seconds, data point of 32 K, Offset of 100 ppm, measuring width of 250 ppm, measuring temperature 70 degrees C.
Measuring nucleus=¹³C (125 MHz), measuring pulse file=single pulse dec.jxp (13C), 45 degrees C. pulse, quantity survey of 64 times, Relaxation Delay 5 seconds, data point of 32 K, Offset of 15 ppm, measuring width of 15 ppm, measuring temperature 65 degrees C.

The major component in amount was determined as matrix (sea portion) in the measuring. The results are shown in Table 1.

### Domain in Cross Section of Coarsely Pulverized Product of Melt-Kneaded Mixture of Toner Compositions

The average number of the domains with an aspect ratio of 2 or greater and an area of 0.1 or more μm² per 100 μm² of the cross section of the coarsely pulverized product of melt-kneaded mixture of toner compositions was calculated from the SEM image of the cross section of the particle of each of the coarsely pulverized products of melt-kneaded mixture of toner compositions of Toners 1 to 6.

### Method of Measuring Area of Domain and Aspect Ratio

One particle of the coarsely pulverized product of melt-kneaded mixture of toner compositions of Toner 1 imaged as described above in the SEM image of cross section was binarized with image processing software Image-Pro Plus 5.1J (available from Media Cybernetics Inc.). From the binarized images, the area of the cross section of the particle of the coarsely pulverized product of melt-kneaded mixture of toner compositions and the area of each visible domain were obtained using an image analysis software “A-zou kun”, available from Asahi Kasei Corporation.

The most extended side and the shortest side were obtained for the domains with an area of 0.1 or more μm² to calculate their aspect ratios. Of these, the number of domains with an aspect ratio of 2 or greater was obtained, and the number of domains with an aspect ratio of 2 or greater and an area of 0.1 or more μm² per 100 μm² of the cross section of the coarsely pulverized product of melt-kneaded mixture of toner compositions was counted.

The number of domains with an aspect ratio of 2 or greater and an area of 0.1 or more μm² per 100 μm² of the cross section of the coarsely pulverized product of melt-kneaded mixture of toner compositions were added. The sum was divided by the number of the used particles (the number of cross sections) of the coarsely pulverized product of melt-kneaded mixture of toner compositions to obtain the average number of the domains with an aspect ratio of 2 or greater and an area of 0.1 or more μm² per 100 μm² of the cross section of the coarsely pulverized product of melt-kneaded mixture of toner compositions of Toner 1.

The same procedure was taken for Toners 2 to 6. The results are shown in Table 1.

If the number of domains with an aspect ratio of 2 or greater and an area of 0.1 or more μm² per 100 μm² of the cross section of the coarsely pulverized product of melt-kneaded mixture of toner compositions in the sea-island structure in the cross section of a particle of the coarsely pulverized product of melt-kneaded mixture of toner compositions is 3 or more on average, the domain in the coarsely pulverized product of melt-kneaded mixture of toner compositions is shown as Yes in Table 1. If the average is less than 3 or no sea-island structure was present in the cross section, it is shown as No.

### Manufacturing of Two Component Developer

### Manufacturing of Carrier

Silicone resin (Organo straight silicone): 100 parts
Toluene 100 parts
γ-(2-aminoethyl) aminopropyl trimethoxy silane: 5 parts
Carbon Black: 10 parts

The mixture specified above was dispersed by a Homomixer for 20 minutes to prepare a liquid for forming a coating layer.

This liquid was applied to Mn ferrite particles with a weight average molecular weight of 35 μm as a core material to achieve an average layer thickness of 0.20 μm on the surface of the core material with a fluid bed type coating device controlling the fluid tank inside at a temperature of 70 degrees C. to obtain dried carrier.

The thus-obtained carrier was baked in an electric furnace at 180 degrees C. for two hours to obtain Carrier A.

### Manufacturing of Two Component Developing Agent

Each of the manufactured toners and Carrier A were uniformly mixed and charged by a TURBULA® mixer (manufactured by Willy A. Bachofen AG) at 48 rpm for five minutes to manufacture each two-component developing agent. The mixing ratio of the toner and the carrier was adjusted to 7 percent by mass, which was the toner concentration of the initial developing agent in the machine used for evaluation.

The two component developing agent obtained was used to form a toner image, which was heat transferred to fabric, followed by evaluating the image. The evaluation method and the conditions are as follows.

### Manufacturing Image for Evaluation

### Example 1

1. A two component developing agent using Toner 1 was placed in the fifth stations of an image forming apparatus, RICOH Pro C7200S, available from Ricoh Co. Ltd. The developing and transfer conditions were adjusted to form a solid image of Toner 1 in the image layer forming region on release paper (WoW light 8.0, available from Piotec Co., Ltd.) to achieve an amount of toner attached to the paper of 1.0 mg/cm².
2. The toner image transferred was then fixed onto the release paper.
3. Fabric of 100 percent polyester was overlapped onto the toner image on the release paper, followed by ironing with an iron at 160 degrees C. under a load of 600 g/cm² for 10 seconds to heat transfer the toner image to the fabric. The toner image was used for evaluation.

### Example 2

An image for evaluation was manufactured in the same manner as in Example 1 except that Toner 1 was replaced with Toner 2.

### Example 3

An image for evaluation was manufactured in the same manner as in Example 1 except that Toner 1 was replaced with Toner 3.

### Example 4

An image for evaluation was manufactured in the same manner as in Example 1 except that Toner 1 was replaced with Toner 4.

### Example 5

An image for evaluation was manufactured in the same manner as in Example 1 except that Toner 1 was replaced with Toner 5.

### Comparative Example 1

An image for evaluation was manufactured in the same manner as in Example 1 except that Toner 6 was replaced with Toner 6.

### Observation on Vertical Cross Section of Fixed Image

Each toner image of Toners 1 to 6 was heat transferred to fabric to form a fixed image, which was then imaged by SEM to obtain a vertical cross section SEM image, where the domain's shape was confirmed. The fixed image was imaged in the same manner as in the method of imaging a cross section of a coarsely pulverized product of melt-kneaded mixture of toner compositions by SEM as described above except that the fixed images of Toners 1 to 6 were used as samples. The results are shown in Table 1.

For the sea-island structure in the vertical cross section of a fixed image fixed by heat transfer to fabric, the fixed image's cross section domain containing a filamentous domain was determined as Yes, while the domain without a filamentous domain was determined as No.

### Method of Evaluating Image Robustness

The fixed images of Examples 1 to 5 and Comparative Example 1 were subjected to Color Fastness to Washing and Laundering Test according to JIS0844:2011 format to evaluate their image robustness.

The toners graded as A to C below were determined as usable as the toner of the present disclosure. The results are shown in Table 1.

### Evaluation Criteria

A: Graded 5 in the Grey scale for assessing change in color according to JIS L 0844 format and no damage to image after laundering 10 times
B: Graded 5 in the Grey scale for assessing change in color according to JIS L 0844 format and image cracking partially occurred after laundering 10 times
C: Graded 4 to 3 in the Grey scale for assessing change in color according to JIS L 0844 format
D: Graded 2 to 1 in the Grey scale for assessing change in color according to JIS L 0844 format

### Method of Evaluating Blocking Resistance

Toners 1 to 6 were allowed to rest at 55 degrees C. and a humidity of 50 percent for 24 hours. The toners were visually evaluated regarding the degree of toner blocking according to the evaluation criteria below.

The toners graded as A to C below were determined as usable as the toner of the present disclosure. The results are shown in Table 1.

### Evaluation Criteria

A: Toner block was not present
B: Only a small number of small toner blocks present, crumbled when lightly poked
C: Small toner blocks present, crumbled when lightly poked
D: Some stiffened toner blocks present, not crumbled when lightly poked

### Method of Evaluating Fixability onto Flexible Medium

An adhesive tape with a certain adhesive force was stuck onto the surface of toner images heat transferred to fabric of Examples 1 to 5 and Comparative Example 1. The adhesive tape was then peeled off, followed by evaluating the toner image remaining on the fabric.

The toners graded as A to C below were determined as usable as the toner of the present disclosure. The results are shown in Table 1.

### Evaluation Criteria

A: Toner not visibly present on tape and density of image where tape was peeled off unchanged
B: Toner barely visible on tape and density of image where tape was peeled off little changed
C: Toner slightly visible on tape and density of image where tape was peeled off little changed
D: Toner clearly visible on tape and density of image where tape was peeled off decreased

TABLE 1

| | | | | | | Comparative |
|---|---|---|---|---|---|---|
| Example | Example 1 | Example 2 | Example 3 | Example 4 | Example 5 | Example 1 |
| Manufacturing Example | 1 | 2 | 3 | 4 | 5 | 6 |
| of toner | | | | | | |
| Domain in cross section | Yes | Yes | Yes | Yes | Yes | No |
| of coarsely pulverized | | | | | | |
| product of melt-kneaded | | | | | | |
| mixture of toner compo- | | | | | | |
| sitions | | | | | | |
| Domain in cross section | Yes | Yes | Yes | Yes | Yes | No |
| of fixed image | | | | | | |
| Sea-island structure of | Polyester resin in matrix (sea portion) | | | | Urethane resin | — |
| cross section of coarsely | Urethane resin in domain (island portion) | | | | in matrix (sea | |
| pulverized product of melt- | | | | | portion) | |
| kneaded mixture of toner | | | | | Polyester resin | |
| compositions and cross | | | | | in domain | |
| section of fixed image | | | | | (island portion) | |
| Softening point Ts | 44 | 43 | Below 40 | Below 40 | Below 40 | 52 |
| | degrees C. | degrees C. | degrees C. | degrees C. | degrees C. | degrees C. |
| tangent method glass | −5 | −8 | −12 | −14 | −15 | 10 |
| transition temperature | degrees C. | degrees C. | degrees C. | degrees C. | degrees C. | degrees C. |
| Tg2nd | | | | | | |
| Fixability | A | A | A | A | B | D |
| Image robustness | B | A | A | A | A | D |
| Blocking resistance | A | A | B | C | C | A |
| Issue in manufacturing | No | Slightly poor | Slightly poor | Poor | Poor | No |
| | | pulverization | pulverization | pulverization | pulverization | |
| | | property | property | property | property | |
| | | | | Adherence to | Adherence to | |
| | | | | wall inside | wall inside | |
| | | | | device | device | |
| | | | | slightly take | significantly | |
| | | | | place | take place | |

The toners of Example 1 to 5 are graded A or B for fixability and image robustness, indicating that they are practically usable as the toner of the present disclosure.

On the other hand, the toner of Comparative Example 1 has a softening point Ts of 50 or higher degrees C., so the toner image after fixing tends to crack. Also, this toner has a tangent method glass transition temperature Tg2nd of 0 or higher degrees C., degrading rubber elasticity and forming an image vulnerable to expanding. The evaluations were thus C for fixability and D for image robustness.

As seen in the results, the toner of the present firmly fixes on a flexible medium such as fabric on which traditional toners are not fixable and demonstrates sufficient flexibility.

Some embodiments of the present disclosure are described above, these embodiments are described for illustration purpose only, and the present invention is not limited thereto. It is to be noted that the following embodiments are not limiting the present disclosure and any deletion, addition, modification, change, etc. can be made within a scope in which man in the art can conceive including other embodiments, and any of which is included within the scope of the present invention as long as the effect and feature of the present disclosure are demonstrated.

Also, various combinations, omissions, replacement, and alterations can be conducted within the scope of the effects of the present invention. Such embodiments and variations are within the scope and effect of the present invention and are included in the invention described in the scope of the claims and their equivalents.

Aspects of the present disclosure are, for example, as follows.

Aspect 1: The toner of the present disclosure has a softening point Ts of lower than 50 degrees C. and a tangent method glass transition temperature Tg2nd of lower than 0 degrees C.

Aspect 2: The toner according to Aspect 1, wherein a sea-island structure is present in a scanning electron microscopic image of a cross section of the toner and has at least three domains, each with an aspect ratio of 2 or more and an area of 0.1 or more μm² per 100 μm² on average.

Aspect 3: The toner according to Aspect 1 or 2, wherein a sea-island structure is present in a scanning electron microscopic image of a vertical cross section of a fixed image of the toner and has a stripe pattern or a filamentous domain.

Aspect 4: The toner according to any one of Aspects 1 to 3, wherein the toner contains a binder resin comprising a polyester resin and a polyurethane resin.

Aspect 5: The toner according to any one of Aspects 2 to 4, wherein the domain contains a polyurethane resin.

Aspect 6: The toner according to Aspect 4 or 5, further contains a releasing agent, wherein the polyurethane resin has a softening point Ts of 45 or less degrees C. and a tangent method glass transition temperature Tg2nd of 45 or less degrees C. and the polyester resin has a softening point Ts of 60 or more degrees C. and a tangent glass transition temperature Tg2nd of 60 or more degrees C., and the polyurethane resin accounts for 5 to 40 percent by mass of an entire of the binder resin and the releasing agent.

Aspect 7: The toner according to any one of Aspects 1 to 6, wherein the toner has a volume average particle diameter of 10 to 20 μm.

Aspect 8: A toner set contains a color toner containing a binder resin and a colorant and the toner of any one of Aspects 1 to 7.

Aspect 9: An image transfer sheet includes a support for releasing and an image formed with the toner of any one of Aspects 1 to 7 on the support.

Aspect 10: A toner accommodating unit includes the toner of any one of Aspects 1 to 7 mentioned above.

Aspect 11. An image forming apparatus includes a latent electrostatic image bearer, a latent electrostatic image forming device to form a latent electrostatic image on the latent electrostatic image bearer, a developing device to develop the latent electrostatic image formed on the latent electrostatic image bearer with a developing agent containing the toner of any one of Aspects 1 to 7 to obtain a toner image, a transfer device to transfer the toner image onto a support for releasing or a flexible printing medium with a surface roughness of 1 or more μm; and a fixing device to fix the toner image transferred to the support or the flexible printing medium.

Aspect 12: An image forming method includes forming a latent electrostatic image on a latent electrostatic image bearer, developing the latent electrostatic image formed on the latent electrostatic image bearer with a developing agent containing the toner of any one of Aspects 1 to 7 to obtain a toner image, transferring the toner image on the latent electrostatic image bearer overlying a support for releasing or a flexible printing medium with a surface roughness of 1 or more μm, and fixing the toner image transferred onto the support or the flexible printing medium.

Aspect 13: The image forming method according to Aspect 12 further includes forming the toner image on the support or the flexible printing medium.

Aspect 14: The image forming method according to Aspect 12 or 13, wherein the flexible printing medium is fabric made from fibers.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A toner having a softening point Ts of below 50 degrees C. and a tangent method glass transition temperature Tg2nd of below 0 degrees C.

2. The toner according to claim 1,
wherein a sea-island structure is present in a scanning electron microscopic image of a cross section of the toner and has at least three domains, each with an aspect ratio of 2 or more and an area of 0.1 or more μm² per 100 μm² on average.

3. The toner according to claim 2,
Wherein a sea-island structure is present in a scanning electron microscopic image of a vertical cross section of a fixed image of the toner and has a stripe pattern or a filamentous domain.

4. The toner according to claim 1, comprising:
a binder resin comprising:
a polyester resin; and
a polyurethane resin.

5. The toner according to claim 2,
wherein the domain comprises a polyurethane resin.

6. The toner according to claim 4, further comprising a releasing agent,
wherein the polyurethane resin has a softening point Ts of 45 or less degrees C. and a tangent method glass transition temperature Tg2nd of 45 or less degrees C., and the polyester resin has a softening point Ts of 60 or more degrees C. and a tangent glass transition temperature Tg2nd of 60 or more degrees C.,
the polyurethane resin accounts for 5 to 40 percent by mass of an entire of the binder resin and the releasing agent.

7. The toner according to claim 1,
wherein the toner has a volume average particle diameter of 10 to 20 μm.

8. A toner set comprising:
a color toner comprising:
a binder resin; and
a colorant; and
the toner of claim 1.

9. An image transfer sheet comprising:
a support for releasing: and
an image formed with the toner of claim 1 on the support.

10. A toner accommodating unit accommodating the toner of claim 1.

11. An image forming apparatus comprising:
a latent electrostatic image bearer;
a latent electrostatic image forming device to form a latent electrostatic image on the latent electrostatic image bearer;
a developing device to develop the latent electrostatic image formed on the latent electrostatic image bearer with a developing agent containing the toner of claim 1 to obtain a toner image;
a transfer device to transfer the toner image onto a support for releasing or a flexible printing medium with a surface roughness of 1 or more μm; and
a fixing device to fix the toner image transferred to the support or the flexible printing medium.

12. An image forming method comprising:
forming a latent electrostatic image on a latent electrostatic image bearer;
developing the latent electrostatic image formed on the latent electrostatic image bearer with a developing agent containing the toner of claim 1 to obtain a toner image;
transferring the toner image on the latent electrostatic image bearer overlying a support for releasing or a flexible printing medium with a surface roughness of 1 or more μm; and
fixing the toner image transferred onto the support or the flexible printing medium.

13. The image forming method according to claim 12, further comprising forming the toner image on the support or the flexible printing medium.

14. The image forming method according to claim 12,
wherein the flexible printing medium is fabric made from fibers.
